(19) United States
(12) Patent Application Publication
(10) Pub. No.: US 2026/0251124 A1
(43) Pub. Date: Aug. 27, 2026

(54) ELONGATE STRUCTURE AND CONSTRUCTION/ASSEMBLY METHOD

(71) Applicant: OSBIT LIMITED, Northumberland (GB)

(72) Inventors: Steven Mark Binney, Northumberland (GB); Michael John Watchorn, Northumberland (GB); James Alexander Hoy, Tyne and Wear (GB)

(21) Appl. No.: 19/162,345

(22) PCT Filed: Mar. 1, 2024
(86) PCT No.: PCT/GB2024/050566

§ 371 Date: Sep. 4, 2025

(30) Foreign Application Priority Data
Mar. 9, 2023 (GB) 2303451.5

(51) Int. Cl. F03D 13/10

(52) U.S. Cl. CPC F03D 13/139; F03D 13/112; F03D 13/126; F05B 2230/61; F05B 2240/95

(57) ABSTRACT

Apparatus and a method of providing a wind turbine (WT) are disclosed. The method comprises the steps of: at a lift position location, erecting a wind turbine portion that comprises at least one elongate tower and a nacelle member on an upper end region of the elongate tower and at least one blade member, by providing a lower tower section at the lift position location, lifting the lower tower section vertically via at least one lift support thereby providing a lifted tower section, urging at least one incoming further tower section to the lift position location, to a position under a preceding tower section, and securing a top region of the incoming further tower section to a lower region of a lifted preceding tower section; whereby lifting tower sections comprises providing tower sections, one-by-one, to the lift position location that is at a desired position proximate to at least one lift support, gripping an incoming tower section via at least one lift beam mounted on respective climber elements movable with respect to each lift support, and via the climber elements raising the gripped tower section upwards to a raised position.

The present invention relates to a method and apparatus for assembly of elongate structures and the elongate structures themselves. In particular, but not exclusively, the present invention relates to quayside or afloat assembly operations for constructing floating offshore wind turbines that include elevated towers.

Conventionally from time-to-time elongate structures need to be constructed. Because of their length and overall size and often large mass involved the creation of such sizable structures is complicated and can be costly.

An example of an elongate structure is a wind turbine (WT). These can be vertical axis wind turbines (VAWTs), or horizontal axis wind turbines (HAWTs) or other species. Most include components mounted atop a long elongate tower. WTs can be used on land or offshore. In each case the creation of the WT and its assembly is a complicated and costly process.

Offshore Floating Wind Turbines are being proposed in the UK, Europe, Eastern and Western Sea Board USA in increasingly large numbers for deep water. Assembly of the increasingly large wind turbines and placing them onto the floating foundations requires cranes of increasing lift and height capability needing to be located close to a suitable quay edge or the use of very large floating or jacked up crane vessels to carry out assembly.

Quay Edge Ground Bearing Capacity can be quite limited without specific investigation, pile driving or Mass Concrete to spread/react applied loads. Average ground loading of 10 to 20 tonnes/m² should be considered for non-modified quayside (to accommodate US quaysides for example) and 25 to 50 tonnes per m² for UK quaysides with heavy lift capability. Load bearing above this needs either advantageous site specific capabilities or pin piling.

Floating assembly rather than quayside assembly of large structures provides complications and difficulties.

Various WT assembly solutions are known such as Self Climbing cranes, very large ring cranes (VLRCs) and large semi-submersible floating cranes.

Self Climbing cranes require modifications to the WT tower to accommodate the climbing mechanism shear connection. The crane is operationally relatively complex and needs significant additional craneage to assist with assembly/disassembly and lift preparation. Self Climbing cranes have been demonstrated on smaller wind turbines but have not been used on large ones required for floating wind turbines.

VLRC's provide both the reach and lift capability for the proposed lifts, however their availability, mobilisation (due to the amount of lorry loads needed to transport the large number of components/counterweights, coupled with the ground foundation requirements for the Ring beam) conspire to both increase the cost of hiring such a crane and also limit the available quaysides that the operations can be caried out from. Such a crane with the associated slew capability provides functionality that is often unnecessary within the context of a wind turbine assembly operation onto a floating foundation due to the limited range of lifts needed and also the ability to move the foundation tripod back and forth to align the lift centres that the floating foundation and the proximity to quayside affords.

Semi-submersible floating cranes have the lift capacity and boom reach to install a fully assembled wind turbine onto a floating platform, but the availability, mobilisation costs and day rate for hire of such equipment are prohibitively high.

A key stage during the creation of an elongate structure such as a WT is the jacking process and a jacking system that can be used during a jacking process is likewise important. It will be appreciated that jacking is a lifting technique. Other lifting techniques are known. Jacking involves the lifting of component parts of the resultant structure step-by-step so separate sections can then be connected together and lifted. Jacking or Lifting systems mounted on the floating WT foundation is problematic due to the additional forces and interfaces required on the floating foundation becoming driving load cases. Also a perceived complexity of primary and secondary structures on top of the floating platform which any jacking system would need to negotiate.

It is an aim of the present invention to at least partly mitigate one or more of the above-mentioned problems.

It is an aim of certain embodiments of the present invention to assemble and install a wind turbine on a floating platform as a floating assembly.

It is an aim of certain embodiments of the present invention to provide an assembly mechanism to operate in higher wind conditions for example over about 14 m/s.

It is an aim of certain embodiments of the present invention to assemble and install a WT with a floating foundation which maybe semi-submersible, tension leg, spar or barge.

It is an aim of certain embodiments of the present invention to provide an assembly mechanism for a structure that can be assembled which can be of a large size and mass and extend for some length in a vertical or horizontal direction.

It is an aim of certain embodiments of the present invention to provide an assembly system and apparatus with both reach and lift capability for the assembly of massive (greater than 10,000 kg) structures.

It is an aim of certain embodiments of the present invention to provide an assembly system and apparatus with both reach and lift capability for the assembly of massive (greater than 1,000,000 kg) structures.

It is an aim of certain embodiments of the present invention to provide a quayside, that is to say land based at an edge of a body of water, assembly methodology and construction equipment for assembling a floating wind turbine or similar structure.

It is an aim of certain embodiments of the present invention to provide a floating vessel, such as a barge or the like, based assembly methodology and a vessel including construction apparatus for constructing/assembling/installing a floating wind turbine.

It is an aim of certain embodiments of the present invention to provide an assembly methodology and apparatus used for assembly of a wind turbine that can be utilised during onerous and possibly extreme weather events, such as high wind conditions without risk of damage to a part constructed wind turbine or other such elongate structure.

According to a first aspect of the present invention there is provided a method of providing a wind turbine (WT), comprising the steps of:
at a lift position location, erecting a wind turbine portion that comprises at least one elongate tower and a nacelle member on an upper end region of the elongate tower and at least one blade member, by providing a lower tower section at the lift position location, lifting the lower tower section vertically via at least one lift support thereby providing a lifted tower section, urging at least one incoming further tower section to the lift position location, to a position under a preceding tower section, and securing a top region of the incoming further tower section to a lower region of a lifted preceding tower section; whereby
lifting tower sections comprises providing tower sections, one-by-one, to the lift position location that is at a desired position proximate to at least one lift support, gripping an incoming tower section via at least one lift beam mounted on respective climber elements movable with respect to each lift support, and via the climber elements raising the gripped tower section upwards to a raised position.

Aptly, the method further comprises:
raising or lowering the climber elements whilst supporting load and resisting moments imparted by a lifted portion of the wind turbine.

Aptly, the method further comprises:
supporting the wind turbine portion from below a centre of gravity of lifted tower sections.

Aptly, the method further comprises:
lifting tower sections further comprises progressively assembling the wind turbine portion using lifting from below a centre of gravity with moment stability and lift loads applied to tower flanges internal and/or external to the incoming tower section.

Aptly, the method further comprises:
once a desired elevation is reached, extending a lift beam guide element of the lift beam into holes of a lift support thereby transferring weight and bending moments of a raised tower section from the lift beam directly to the lift support.

Aptly, the method further comprises:
via at least one gripper mounted on the lift beam, engaging with the outside or inside of a tower section thereby allowing lift forces and support moments of the wind turbine portion to be transmitted to the lift support.

Aptly, the method further comprises:
the climber elements can progressively climb a rigid frame structure.

Aptly, the method further comprises:
the climber elements each include a lower climbing element and an upper climbing element.

Aptly, the method further comprises:
each lower climbing element is connected to a respective upper climbing element by at least one hydraulic cylinder.

Aptly, the method further comprises:
raising or lowering the climber elements by repeatedly increasing and decreasing a distance between a spaced apart lower climbing element and an upper climbing element of each climber element.

Aptly, the method further comprises:
repeatedly lifting a respective tower section and providing an incoming tower section under one or more lifted tower sections until a tower portion comprising a plurality of tower sections is erected.

Aptly, the method further comprises:
lifting tower sections by providing tower sections, one-by-one, to the lift position location that is at a desired position proximate to at least one lift support, gripping an incoming tower section via one or more lift beams vertically separated and mounted on respective climber elements movable with respect to each lift support, and via the climber elements raising the gripped tower section upwards to a raised position.

Aptly, the method further comprises:
providing tower sections one-by-one to the lift position location by providing a plurality of upright tower sections on respective skidding frames running on a rail track, and selectively urging each skidding frame along a region of the rail track to the lift position location.

Aptly, the method further comprises:
providing tower sections one-by-one to the lift position location by providing a plurality of upright tower sections via SPMTs (self-propelled modular transporter).

Aptly, the method further comprises:
supporting a supported tower section of an elongate tower comprising a plurality of tower sections, via a lift beam supported by each lift support, and simultaneously supporting a further tower section of the elongate tower via a skidding frame.

Aptly, the method further comprises:
supporting a supported tower section of an elongate tower comprising a plurality of tower sections, via one or more lift beams vertically separated and supported by each lift support, and simultaneously supporting a further tower section of the elongate tower via a skidding frame.

Aptly, the method further comprises:
subsequent to erecting said a wind turbine portion, urging the erect wind turbine portion laterally over a region of a floating platform to a mounting position.

Aptly, the method further comprises:
as the erect wind turbine portion is urged over said a region, holding the floating platform at a desired relative position via at least one gripper member and optionally via a pair of opposed gripper members.

Aptly, the method further comprises:
as the wind turbine portion is urged over said a region, selectively varying a buoyancy of at least one respective buoyancy element proximate to the gripper member to balance a transfer of weight provided by the wind turbine portion with a buoyancy associated with the buoyancy element.

Aptly, the method further comprises:
providing a region of the floating platform under the erect wind turbine and optionally holding the floating platform at a desired relative position via at least one gripping member.

Aptly, the method further comprises:
selectively securing one or more blade members to a rotor hub carried with the nacelle, via a crane element, with the nacelle facing the floating platform or rotating the elongate tower and/or the nacelle at the lift position location and securing each blade member to the rotor hub via a gantry system or other means.

Aptly, the method further comprises:
the lift position location is a quayside zone adjacent to a body of water in which the floating platform floats or is a zone on a barge itself floating in a body of water.

Aptly, the method further comprises:
when a barge is used, the floating platform can be located offshore in a remote location.

Aptly, the method further comprises:
prior to securing the lower region, determining a first dimension relative position of the lower region via lateral movement of at least one lift support along a respective lift support track.

Aptly, the method further comprises:
prior to securing the lower region, determining a further dimension position of the tower end region via selectively laterally moving at least one gripper member that grips a region of the floating platform.

Aptly, the method further comprises:
prior to securing the lower region, determining a degree of rotation of a lifted tower section by selecting a control index rotation of a lifting beam that supports the lifted tower section.

Aptly, the method further comprises:
prior to securing tower sections, either to each other or a foundation, providing a quantity of rotation to the lifted or lower tower section for the purpose of alignment by controlled rotation of a lifting beam that supports the tower sections.

Aptly, the method further comprises:
via a final skidding frame supporting a lower tower section, providing a moment carrying connection to support a tower section and/or providing a locating and skidding connection to horizontal rails of a rail track and/or providing a vertical height adjusting connection and a rotational alignment adjusting connection.

According to a second aspect of the present invention there is provided apparatus for providing a wind turbine (WT), comprising:
at least one lift support each comprising a respective climber element for relative movement up or down the lift support; and
a rail track extending from a first rail track end to a remaining rail track end; wherein the rail track is disposed for delivery of successive tower sections each mounted on respective skid frames to a lift position location proximate to said lift support.

Aptly, the apparatus further comprises:
a lift beam mounted on respective climber elements moveable with respect to each lift support for gripping an incoming tower section at a lift position location.

Aptly, the apparatus further comprises:
at least one gripper mounted on the lift beam for engaging with an outside or an inside of a tower section thereby allowing lift forces and support moments of the wind turbine portion to be transmitted to the at least one lift support.

Aptly, the apparatus further comprises:
each lift support comprises a jacking tower that includes a vertically arranged track of blind or through holes.

Aptly, the apparatus further comprises:
said respective climber elements are for raising a tower section of the wind turbine to a raised position.

Aptly, the apparatus further comprises:
said respective climber elements comprise a lower climbing element connected to an upper climbing element by a pair of hydraulic cylinders.

Aptly, the apparatus further comprises:
a lift beam guide element of the lift beam for transferring weight and bending moments of a raised tower section of the wind turbine from the lift beam directly to the at least one lift support.

Aptly, the apparatus further comprises:
a crane or gantry proximate to the lift position location for raising rotor blade members one-by-one for attachment to a rotor hub element of the wind turbine.

Aptly, the apparatus further comprises:
each lift support is mounted on a respective track for translating the lift support along said respective track.

Aptly, the apparatus further comprises:
the wind turbine is a floating wind turbine, the apparatus further comprising at least one gripper member, said gripper member is for securing a floating platform at a desired location.

According to a third aspect of the present invention there is provided a method of providing a floating wind turbine (WT), comprising the steps of: at a lift position location, erecting a wind turbine portion that comprises at least one elongate tower, a nacelle member on an upper end region of the elongate tower and at least one blade member; and securing a lower end region of the elongate tower to a floating platform thereby providing a floating wind turbine.

Aptly, the method further comprises erecting the wind turbine portion by providing a lower tower section at the lift position location; lifting the lower tower section vertically via at least one lift support thereby providing a lifted tower section; urging at least one incoming further tower section, to the lift position location, to a position under a preceding tower section; and securing a top region of the incoming further tower section to a lower region of a lifted preceding tower section. Aptly, the lower tower section is an initial tower section.

Aptly, the method further comprises repeatedly lifting a respective tower section and providing an incoming tower section under one or more lifted tower sections until a tower portion comprising a plurality of tower sections is erected.

Aptly, the method further comprises lifting tower sections by providing tower sections, one-by-one, to the lift position location that is at a desired position proximate to at least one lift support; gripping an incoming tower section via a lift beam mounted on respective climber elements movable with respect to each lift support; and via the climber elements raising the gripped tower section upwards to a raised position.

Aptly, the method further comprises lifting tower sections by providing tower sections, one-by-one, to the lift position location that is at a desired position proximate to at least one lift support; gripping an incoming tower section via one or more lift beams vertically separated and mounted on respective climber elements movable with respect to each lift support; and via the climber elements raising the gripped tower section upwards to a raised position.

Aptly, the climber elements are an example of an elevation system.

Aptly, the method further comprises providing tower sections one-by-one to the lift position location by providing a plurality of upright tower sections on respective skidding frames running on a rail track; and selectively urging each skidding frame along a region of the rail track to the lift position location.

Aptly, the method further comprises providing tower sections one-by-one to the lift position location by providing a plurality of upright tower sections via SPMTs (self-propelled modular transporter).

Aptly, the method further comprises supporting a supported tower section of an elongate tower comprising a plurality of tower sections, via a lift beam supported by each lift support; and simultaneously supporting a further tower section of the elongate tower via a skidding frame.

Aptly, the method further comprises supporting a supported tower section of an elongate tower comprising a plurality of tower sections, via one or more lift beams vertically separated and supported by each lift support; and simultaneously supporting a further tower section of the elongate tower via a skidding frame.

Aptly, the method further comprises, subsequent to erecting said a wind turbine portion, urging the erect wind turbine portion laterally over a region of a floating platform to a mounting position.

Aptly, the method further comprises, as the erect wind turbine portion is urged over said a region, holding the floating platform at a desired relative position via at least one gripper member and optionally via a pair of opposed gripper members.

Aptly, the method further comprises, as the wind turbine portion is urged over said a region, selectively varying a buoyancy of at least one respective buoyancy element proximate to the gripper member to balance a transfer of weight provided by the wind turbine portion with a buoyancy associated with the buoyancy element.

Aptly, the method further comprises providing a region of the floating platform under the erect wind turbine and optionally holding the floating platform at a desired relative position via at least one gripping member.

Aptly, the method further comprises selectively securing one or more blade members to a rotor hub carried with the nacelle, via a crane element, with the nacelle facing the floating platform or rotating the elongate tower and/or the nacelle at the lift position location and securing each blade member to the rotor hub via a gantry system or other means.

Aptly, the method further comprises the lift position location is a quayside zone adjacent to a body of water in which the floating platform floats or is a zone on a barge itself floating in a body of water.

Aptly, when a barge is used the floating platform can be located offshore in a remote location.

Aptly, the method further comprises, prior to securing the tower end region, determining a first dimension relative position of the tower end region via lateral movement of at least one lift support along a respective lift support track.

Aptly, the method further comprises, prior to securing the tower end region, determining a further dimension position of the tower end region via selectively laterally moving at least one gripper member that grips a region of the floating platform.

Aptly, the method further comprises, prior to securing the tower end region, determining a degree of rotation of a lifted tower section by selecting a control index rotation of a lifting beam that supports the lifted tower section.

Aptly, the method further comprises, prior to securing the tower sections, either to each other or the foundation, providing a quantity of rotation to the lifted or lower tower section for the purpose of alignment by controlled rotation of a lifting beam that supports the tower sections.

Aptly, the method further comprises, via a final skidding frame supporting a lower tower section, providing a moment carrying connection to support a tower section and/or providing a locating and skidding connection to horizontal rails of a rail track and/or providing a vertical height adjusting connection and a rotational alignment adjusting connection.

According to a fourth aspect of the present invention there is provided apparatus for providing a floating wind turbine (WT), comprising: at least one lift support each comprising a respective climber element for relative movement up or down the lift support; a rail track extending from a first rail track end to a remaining rail track end; and at least one gripper member for securing a floating platform at a desired location; wherein the rail track is disposed for delivery of successive tower sections each mounted on respective skid frames to a lift position location proximate to said lift support.

Aptly, the at least one support comprises a pair of spaced apart support frames each support frame comprising a rigid vertical support that extends away from a support surface; and the rail track extends between the spaced apart support frames, a position lying on the track and between the spaced apart supports corresponding with the lift position location.

Aptly, the lift position location is a position between at least one and optionally between at least two supports. The lift position may be offset to some extent from a position directly between two points if the lift supports include a cantilever.

Aptly, each support comprises a jacking tower that includes a vertically arranged track of blind or through holes.

Aptly, each support is disposed on a support skid carriage that is locatable along a respective support skidding track adjacent to the said a rail track.

Aptly, each support skid carriage is locatable along the support frame skidding track between a first position, at which the support on the support skidding carriage is adjacent to a lift position location, and a second position at which the support is locatable at a position to lower a wind turbine portion onto a floating platform.

Aptly, the apparatus further comprises a crane or gantry proximate to the lift position location for raising rotor blade members one-by-one for attachment to a rotor hub element of the wind turbine portion.

According to a fifth aspect of the present invention there is provided a barge or quayside region comprising the apparatus/of the fourth aspect.

According to a sixth aspect of the present invention there is provided a floating wind turbine comprising the wind turbine portion and floating platform of the fourth aspect.

According to a seventh aspect of the present invention there is provided a method for decommissioning or maintenance of a floating wind turbine (WT), comprising the steps of: locating of a floating wind turbine comprising a floating platform at a decommissioning or maintenance position and gripping a portion of the floating platform via at least one gripping member; unsecuring a lower end region of an elongate tower of the wind turbine from the floating platform; urging a wind turbine portion comprising the unsecured tower and associated nacelle member and at least one blade member away from the floating platform to a lift position location; and subsequently removing at least one of a blade member and/or a tower section and/or nacelle member from the wind turbine portion with a remaining tower section of the wind turbine portion supported via at least one of a skid frame on a rail track or a lift support adjacent to the remaining tower section.

Aptly, the method further comprises, at the lift position location, clamping a remaining tower section at least two spaced apart locations via a respective skid frame and at least one lift beam connected to at least one support.

Aptly, the method further comprises urging the wind turbine portion laterally away from the floating platform and/or urging the wind turbine portion vertically upwards away from a mount position on the floating platform.

Aptly, the method further comprises removing tower sections one-by-one at the lift position location by unsecuring tower sections and lifting an upper one or more tower sections simultaneously and removing a lowest tower section on a skid frame along a rail track or other delivery route such as SPMT (self-propelled modular transporter).

Aptly, the method further comprises replacing a used nacelle member with a further nacelle member and subsequently re-erecting an elongate tower and securing one or more rotor blades to a rotor hub; and subsequently securing a tower end region of said an elongate tower that comprises the further nacelle member to a floating platform.

Certain embodiments of the present invention provide an elongate structure and a method of assembling an elongate structure.

Certain embodiments of the present invention provide a floating offshore wind turbine (WT) and a method of assembling a floating offshore WT.

Certain embodiments of the present invention provide a land based jacking rig and translation assembly whereby an assembled wind turbine can be translated out from a quayside region over a floater (floating platform support) using buoyancy supported rails to reduce a magnitude of forces applied to the quayside region.

Certain embodiments of the present invention provide a land based jacking rig (or other lifting device) and translation assembly whereby an assembled wind turbine can be translated out from a quayside region over a floater (floating platform support) using cantilever lifting to reduce a magnitude of forces applied.

Certain embodiments of the present invention provide a floating or offshore jacking rig and translation assembly where an assembled wind turbine can be translated out from a barge or ship or the like over a floater (floating platform support) using buoyancy supported rails on the barge or ship to reduce a magnitude of forces applied.

Certain embodiments provide buoyancy supported rails which are rails directly mounted on the barge/ship and the barge/ship being ‘U’shaped at the front ready to receive the floater.

Certain embodiments of the present invention provide an assembly technique which lowers a height that a primary lift is needed for a nacelle lift step with respect to conventional techniques allowing more readily available mobile or crawler cranes to be used as a basis for primary lifting. This helps remove a need for VLRC or large floating cranes.

Certain embodiments of the present invention provide that nacelle, hub, blades and tower loads and moments experienced during assembly are carried by a combination of the jacking rig and skidding systems directly exerted into one or more flange areas of the WT tower. This is a naturally high strength area of the WT designed to transmit/withstand high forces.

Certain embodiments of the present invention provide that the lift system places the fully assembled turbine onto a floating platform.

Certain embodiments of the present invention provide that one or more lift beams provide lifting and rotational indexing of the components to assist with alignment of various fastener patterns including the fully assembled WT as it is located with a Foundation bolt pattern.

Certain embodiments of the present invention provide that a skidding system can provide rotational indexing and alignment of the components being installed to align the fasteners. This is an improvement on conventional indexing using highly loaded lift beam connections.

Optionally a fastener is a bolt pattern.

Certain embodiments of the present invention provide that a jacking rig remains at the bottom of the tower at all times. This helps by not having to be lowered at the end of the assembly from the top of the mast and not adding a driving case to the wind turbine tower design.

Certain embodiments of the present invention provide that blade installation is improved by being conducted at lower height than is possible in traditional lifted assembly processes.

Certain embodiments of the present invention provide that the application of the two point grippers from a gantry structure can assist in controlling a blade in higher wind conditions, improving both safety and weather window for the operation.

Certain embodiments of the present invention provide that a quayside or barge or ship based gripper assembly helps to control and position a floating platform such as tripod relative to the land based lift equipment for several different phases of the installation process including moving the floating platform between locations.

Certain embodiments of the present invention provide that the Quayside or Barge or Ship based Gripper can help to control precise motion of the foundation during alignment and assembly.

Certain embodiments of the present invention provide that a Quayside or Barge or Ship based Gripper permits control and movement of the floating platform reducing the reliance on mooring systems/winch ropes with associated increase in safety.

Certain embodiments of the present invention provide that the assembly system integrates with existing and available mobile or crawler cranes allowing these cranes to be utilized to assemble larger WT than can be otherwise achieved by normal lifting assembly operations.

Certain embodiments of the present invention provide that a variable Buoyancy frame helps allow loads exerted into the quay edge to be minimized and the forces to be transmitted away from the floating foundation until the final bolted installation joint is complete.

Certain embodiments provide that the buoyancy is only required to react the vertical load and that it is stabilised and moments reacted by a pivoting stability frame mounted to the quay or seabed.

Certain embodiments of the present invention provide that using buoyancy to counteract the full WT and jacking Rig loads provides progressive and variable support, which is helpful with soft landing and avoiding shock loading of the WT and the foundation as they are mated.

Certain embodiments of the present invention provide that a large reach crane to disassemble/remove the lift system at the end of the assembly process is not needed. The proposed system remains at the bottom of the tower and is removed by simply skidding empty jacking towers back into a land assembly position.

Certain embodiments of the present invention provide that the proposed equipment allows multiple wind turbines to be at different stages of assembly reducing the number of critical path lifts needed to assemble the wind turbine.

Certain embodiments of the present invention provide that the proposed equipment allows for places of safety part way through the assembly operation allowing a reduction in a length of weather sensitive operations. This helps increase the efficiency of operation and reduce the weather risk.

Certain embodiments of the present invention provide that blade installation is carried out at lower height than with certain known techniques which improves wind loading on the blades and/or reduces wind loading on the blades due to a reduced height.

Certain embodiments of the present invention provide that blade installation can be conducted using twin guides supported by lightweight gantries that are widely separated helping to stabilize the blade and improve the wind conditions that blade assembly can be safely carried out. This helps increase an envelope of use.

Certain embodiments of the present invention provide that progressive assembly of wind turbine with mast sections installed from below a centre of gravity with the jacking system lifting up the WT to provide space for the next part of the tower to be placed below.

Certain embodiments of the present invention provide that progressive assembly of wind turbine using lifting from below centre of gravity with moment stability and lift loads applied to shapes on the tower flanges internal and/or external of tower to manage applied wind loading, off vertical loads and weight.

Certain embodiments of the present invention provide that many or all lifts are guided and controlled removing a need for use of tugger lines and therefore consequently removing the inherent associated safety risks.

Certain embodiments of the present invention provide an opportunity to install nacelle and blades at lower than full/final hub height.

Certain embodiments of the present invention provide an opportunity to use more readily available cranes than VLRCs and/or large floating or jacked up cranes to assemble WTs.

Certain embodiments of the present invention provide multiple lift and guidance of wind turbine blades for improved assembly in higher wind conditions. This leads to improved safety and operability.

Certain embodiments of the present invention provide that combination of Quayside or Barge or Ship based Gripper and Blade Support Gantry assembly for improved alignment and moment control during blade installation and bolt mounting.

Certain embodiments of the present invention provide for Quayside or Barge or Ship based Gripper moving and referencing floating foundation during assembly operations.

Certain embodiments of the present invention provide that WT to floating platform during final alignment and placement of previously installed components due to lift rig support onto separate floating support.

Certain embodiments of the present invention provide WT movement and placement over floating platform by rail mounted skidding system.

Certain embodiments of the present invention provide floating buoyancy support which provides controlled weight transfer as a WT is moved from land to over a floating platform. Buoyancy can selectively be controlled by pumping water out of and into Buoyancy supports.

Certain embodiments of the present invention provide that the buoyancy support structures are optionally fully submergible, removing the impact of tidal and wave variation on the lift process.

Certain embodiments of the present invention provide that a floating platform is stabilised during assembly by rails being in contact with land based or barge or ship based reaction pads and crossbeam that supports a quayside or barge or ship based gripper.

Certain embodiments of the present invention provide rotational index control and alignment of WT Mast fasteners for improved alignment and fastener engagement.

Optionally, a fastener may be a bolt.

Certain embodiments of the present invention provide rotational indexing compliance provided by a land or afloat-based Skidding rig “Knee bearing” using bridge bearing multiplate elastomer deflection to allow support force in vertical direction coupled with the ability to provide a small amount of lateral translation and index rotation without suffering from backlash or stick-slip behaviour.—The hole pitch (140 mm) at 5.26 m PCR equates to 0.763 deg rotation. To help support the vertical WT weight the system optionally includes 4 off elastomer bridge bearings (9694 kN load capacity) have 18 mm shear capacity. 4 bearings in a central tile helps provide a rotational capacity using the shear of +/−1.90 degree which is more than twice the necessary rotation.

Certain embodiments of the present invention provide a land or afloat-based skidding system knee bearing which helps provide an ability to react moments and subsequently progressively reduce moment restraint when aligning things and then by changing control state of the hydraulic cylinders at the outer edges a way of reacting the wind induced moments into the hydraulic cylinders.

Certain embodiments of the present invention provide for the assembly of an elongate, that is to say long, that is to say more than 10 metres long and optionally more than 20 metres long structure which can be erected by part/section and whereby the assembly process can be carried out in high wind conditions without risk of toppling and catastrophic failure.

Certain embodiments of the present invention provide a lift methodology using climber elements which can progressively climb a rigid frame structure to lift a physically massive/ heavy object.

Certain embodiments of the present invention provide a methodology and apparatus for counterbalancing transfer of mass/weight of a massive object, such as a wind turbine portion or the like as it is moved from a rigid land or vessel based location to a floating platform. This allows translation of the wind turbine portion laterally without having to encounter a significant slope and enables the floating platform to be provided adjacent to the land-based location (or floating vessel-based location) in a floating state.

Certain embodiments of the present invention provide a methodology and apparatus for decommissioning and/or maintenance of an elongate structure such as a floating wind turbine or the like. In such embodiments a floating wind turbine can be brought alongside a quayside (land-based location) or alongside a floating vessel such as a maintenance barge or the like, and then a wind turbine portion comprising the tower and nacelle and rotors can be lifted off the floating platform and subsequently disassembled on the quayside or on the barge and one or more elements of the wind turbine portion replaced. This helps replace broken or old portions of the floating wind turbine portion. Thereafter the wind turbine portion can be reassembled and then lifted again onto the floating platform where it is secured at a mount position and then the floating wind turbine can be floated away for reuse.

Certain embodiments of the present invention provide a gantry system which can be utilised to successively load rotor blades of a wind turbine onto a rotor hub of a wind turbine supported by a rotor shaft in a nacelle. The gantry system enables rotor blades to be held in a fixed location for securing to the rotor hub. The fixed location helps fix at least two and optionally three dimensions of movement of each rotor blade which provides an effective mechanism/methodology for mounting of rotor blades.

Certain embodiments of the present invention provide a skidding frame which can be used to translate, that is to say laterally move in a dimension, a massive object. Optionally the massive object has a weight of 10,000 kg or more. Optionally the massive object has a weight of 1,000,000 kg or more. The skidding frame that can move the object thus carrying it along a desired pathway also fixes the base area of the massive object whilst the object is held in an upright position. This helps avoid toppling of the elongate element.

Embodiments of the present invention will now be described hereinafter, by way of example only, with reference to the accompanying drawings in which:

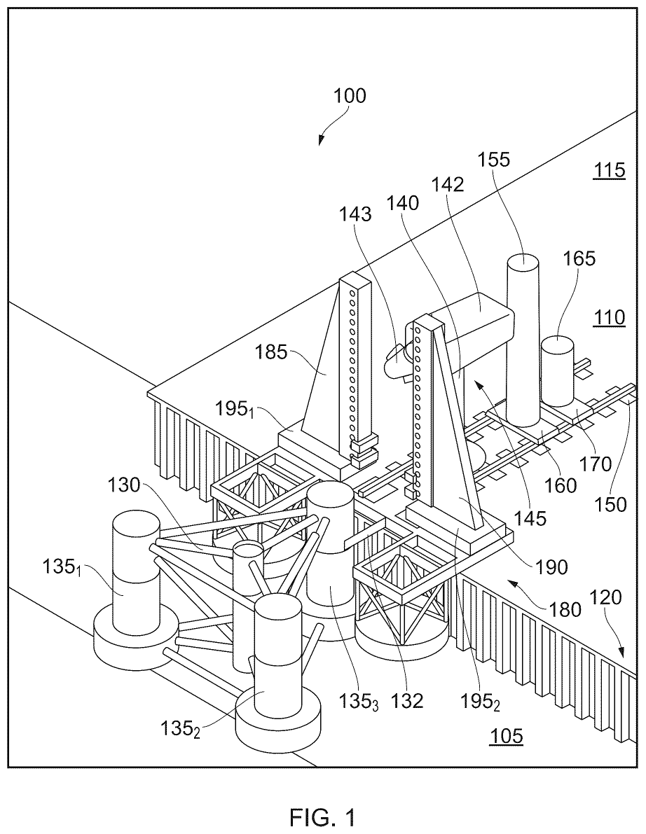

FIG. 1 illustrates a quayside environment and a floating platform;

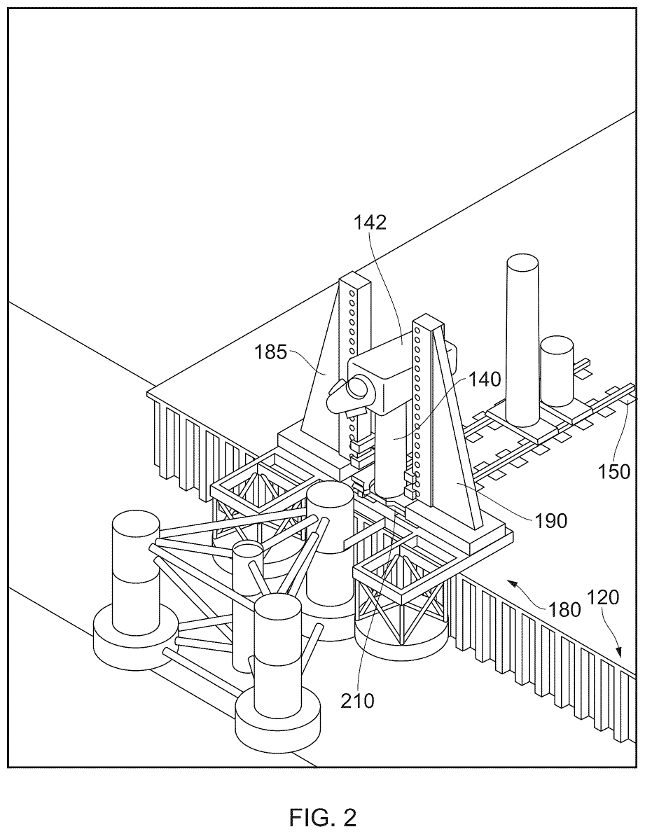

FIG. 2 illustrates moving an upper tower section of a wind turbine in an assembly process for assembling the wind turbine on a quayside;

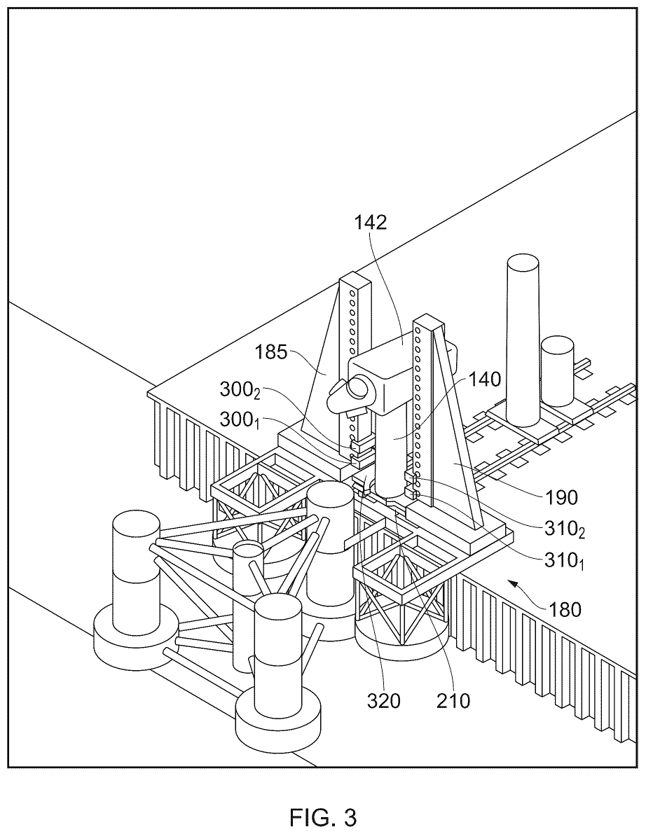

FIG. 3 illustrates securing an upper tower section of a wind turbine to a jacking rig in an assembly process for assembling the wind turbine;

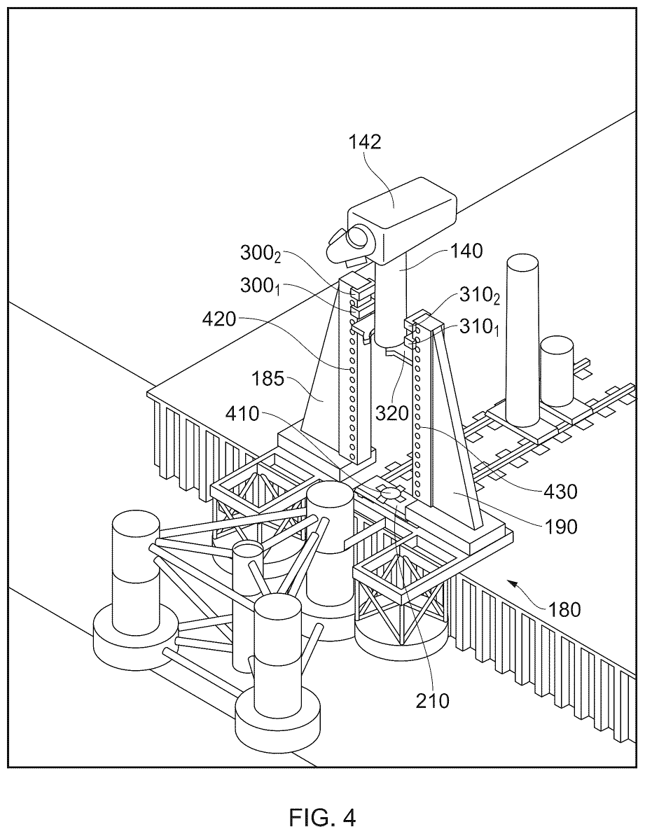

FIG. 4 illustrates raising an upper tower section of a wind turbine on a jacking rig in an assembly process for assembling the wind turbine;

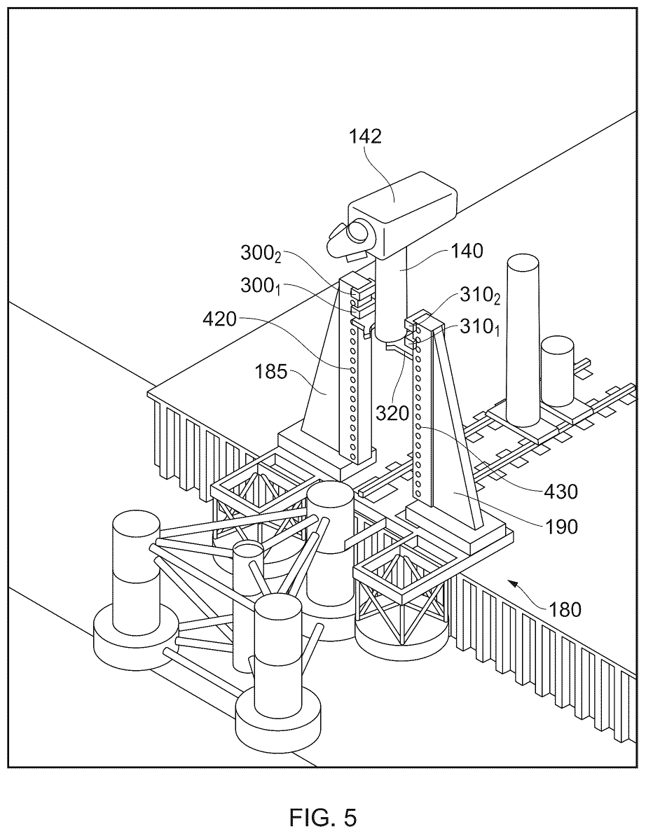

FIG. 5 illustrates removing a skiddable carriage from under an upper tower section of a wind turbine in an assembly process for assembling the wind turbine;

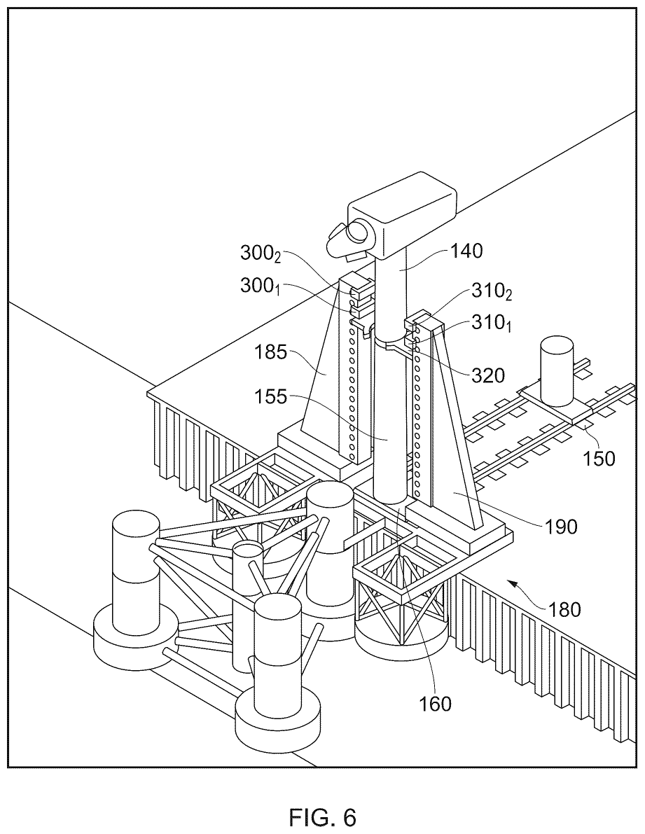

FIG. 6 illustrates moving an intermediate tower section of a wind turbine in an assembly process for assembling the wind turbine;

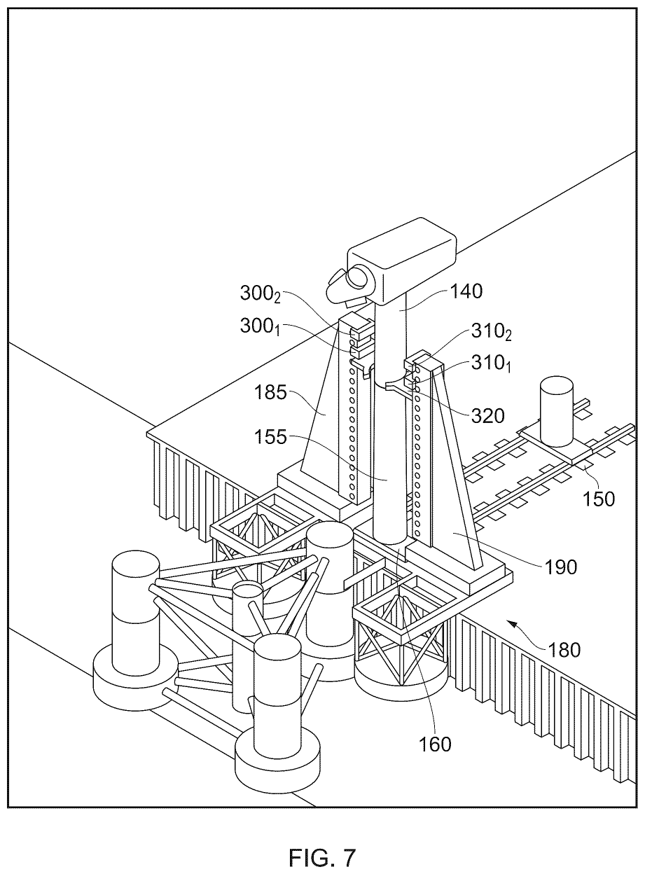

FIG. 7 illustrates securing an intermediate tower section of a wind turbine to an upper section of the wind turbine in an assembly process for assembling the wind turbine;

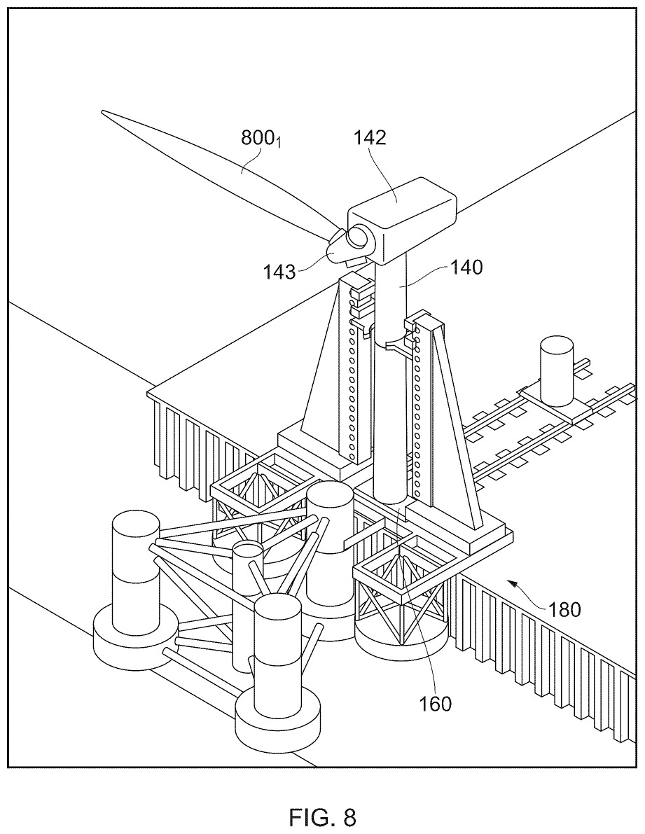

FIG. 8 illustrates installing a first blade onto a wind turbine in an assembly process for assembling the wind turbine;

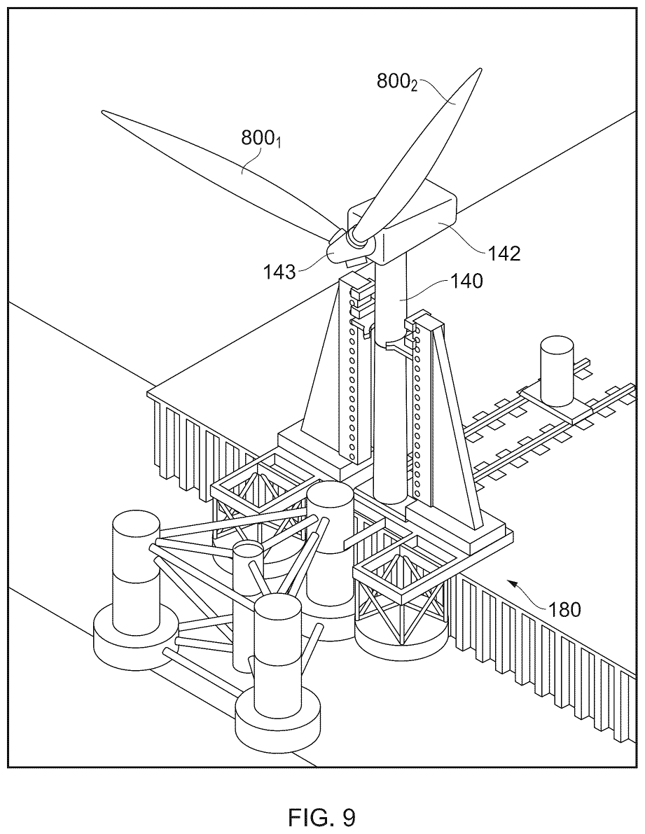

FIG. 9 illustrates installing a second blade onto a wind turbine in an assembly process for assembling the wind turbine;

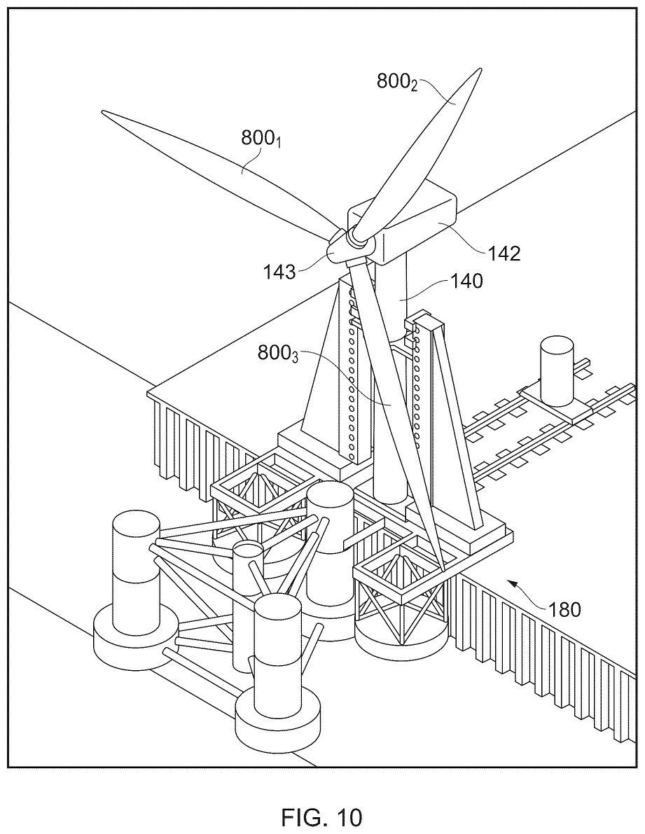

FIG. 10 illustrates installing a third blade onto a wind turbine in an assembly process for assembling the wind turbine;

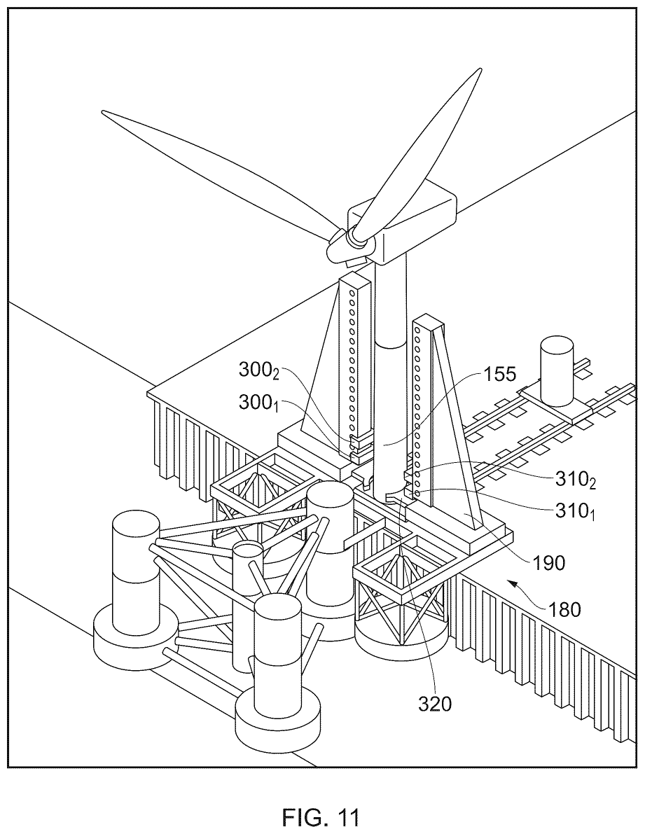

FIG. 11 illustrates lowering a lift carriage around a partially-constructed wind turbine in an assembly process for assembling the wind turbine;

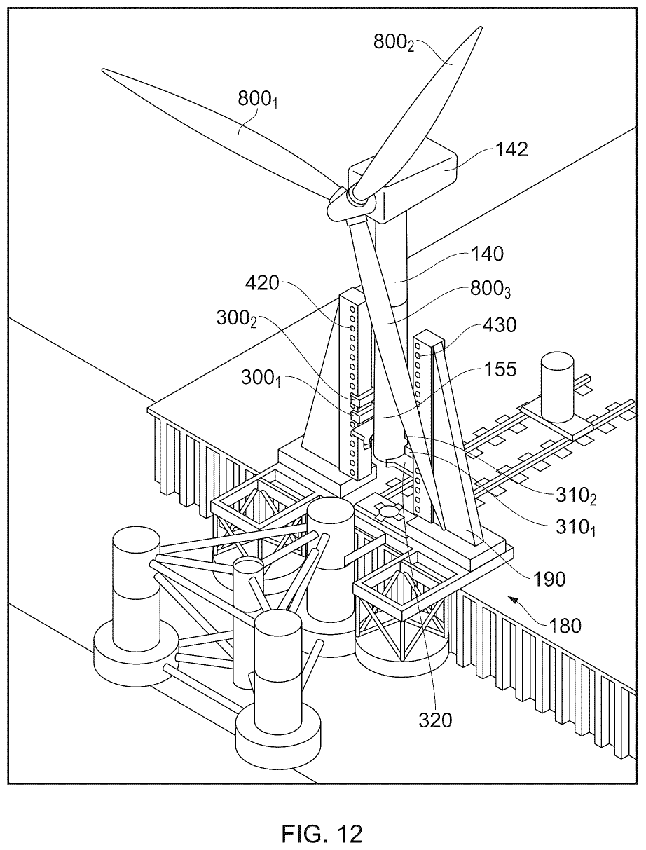

FIG. 12 illustrates raising an upper tower section of a wind turbine and an intermediate tower section of the wind turbine on a jacking rig in an assembly process for assembling the wind turbine;

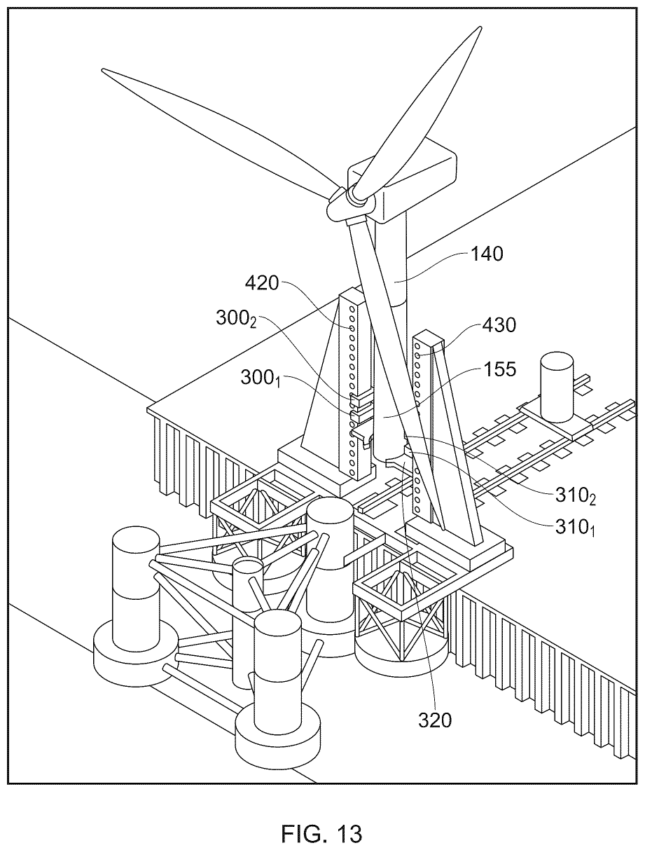

FIG. 13 illustrates removing a skiddable carriage from under an intermediate tower section of a wind turbine in an assembly process for assembling the wind turbine;

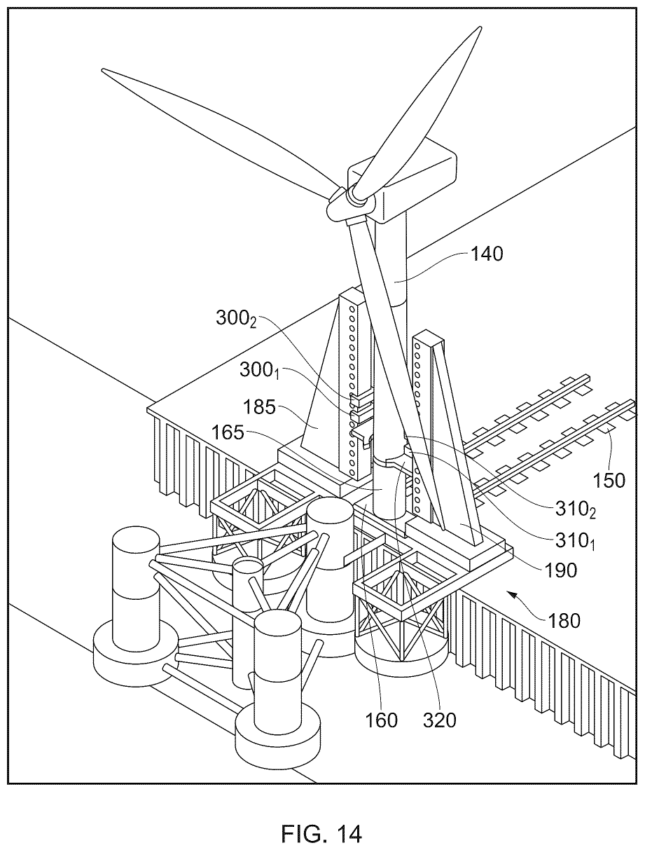

FIG. 14 illustrates moving a lower tower section of a wind turbine in an assembly process for assembling the wind turbine;

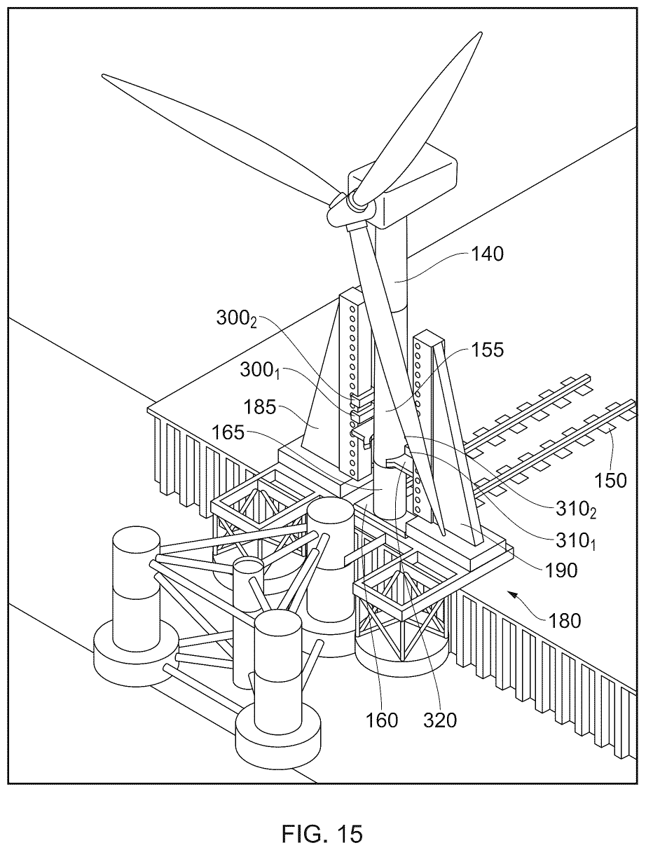

FIG. 15 illustrates securing a lower tower section of a wind turbine to an intermediate section of the wind turbine in an assembly process for assembling the wind turbine;

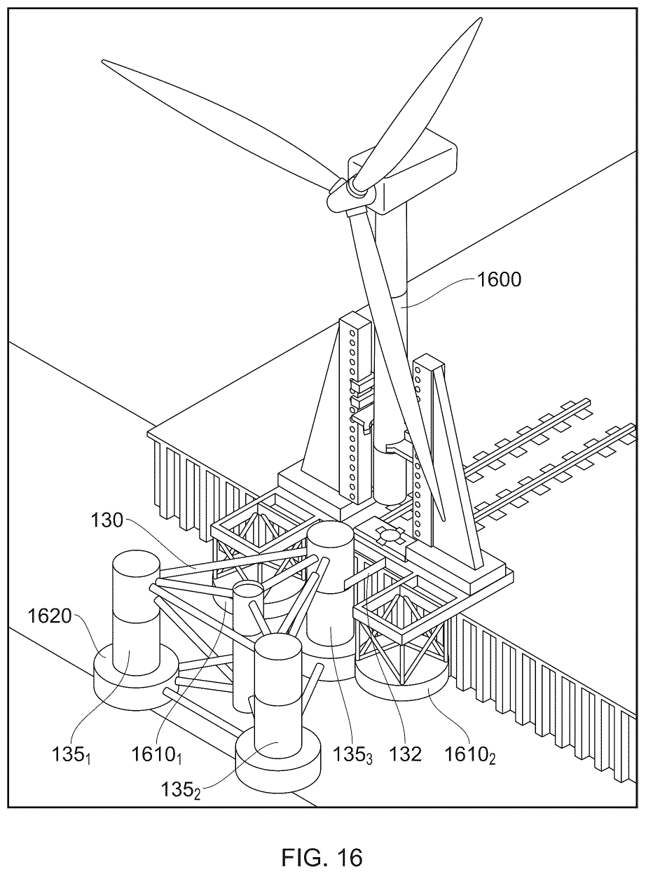

FIG. 16 illustrates raising an assembled wind turbine on a jacking rig;

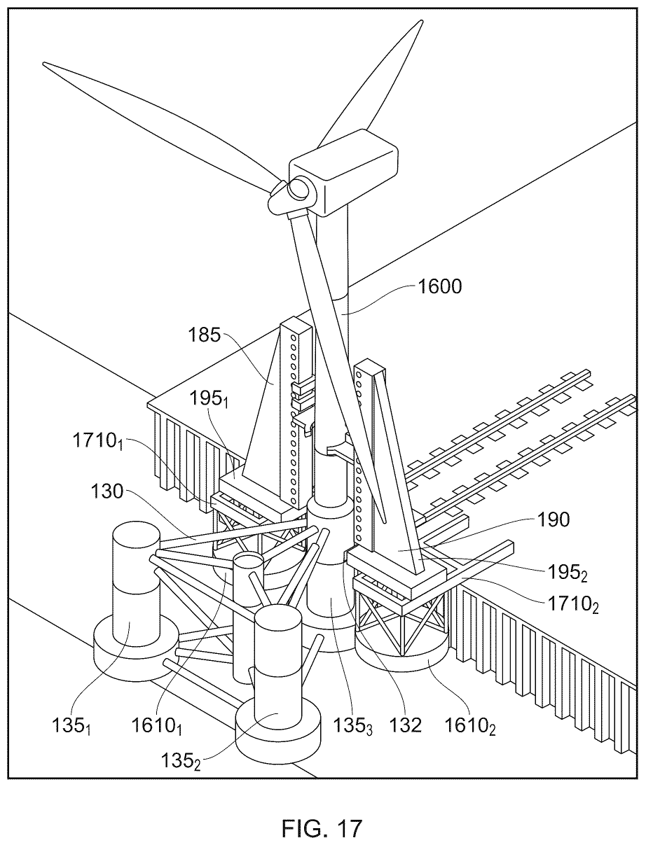

FIG. 17 illustrates moving a jacking rig holding an assembled wind turbine to overhang a quayside and thus be above a floating platform;

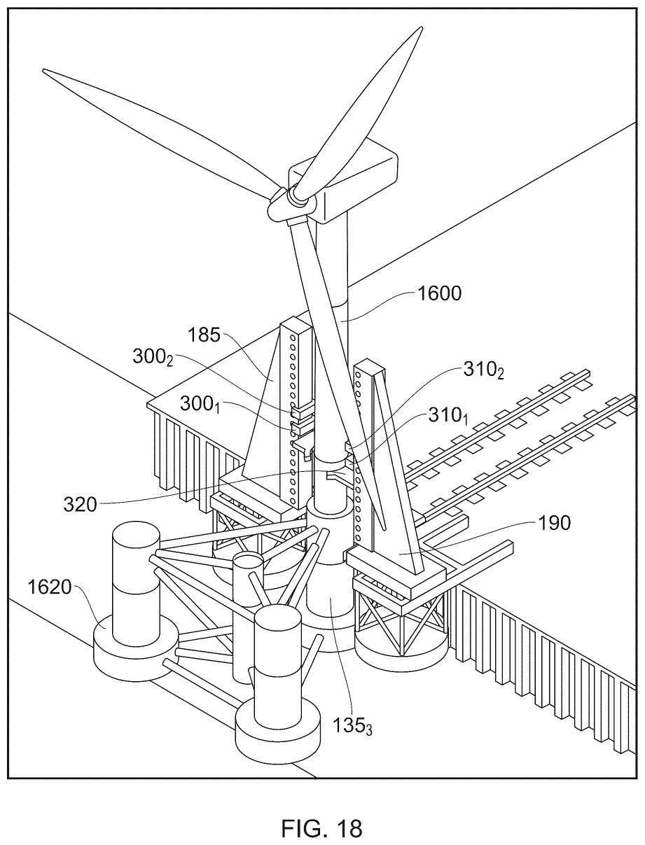

FIG. 18 illustrates lowering an assembled wind turbine on a jacking rig;

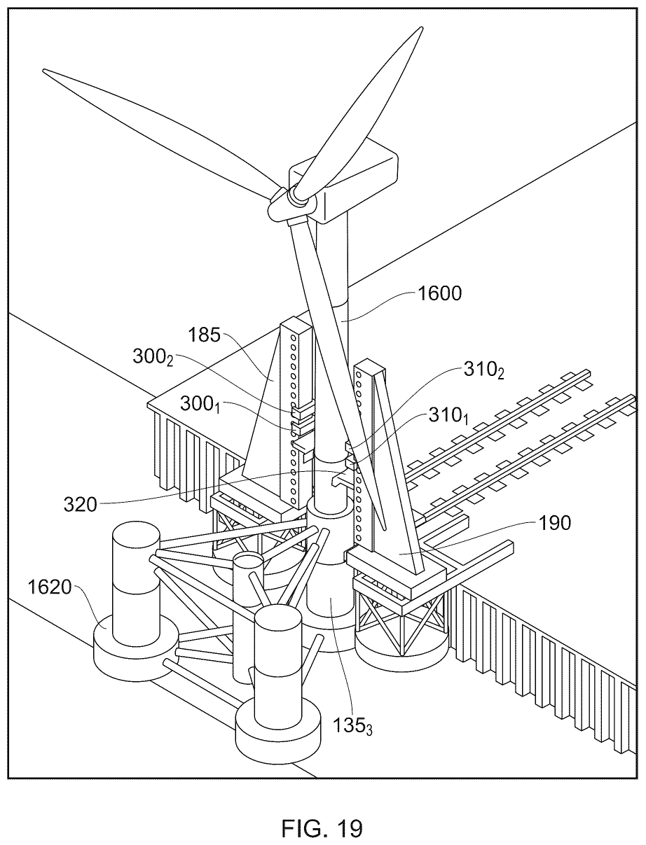

FIG. 19 illustrates releasing an assembled wind turbine, secured to a floating platform, from a jacking rig;

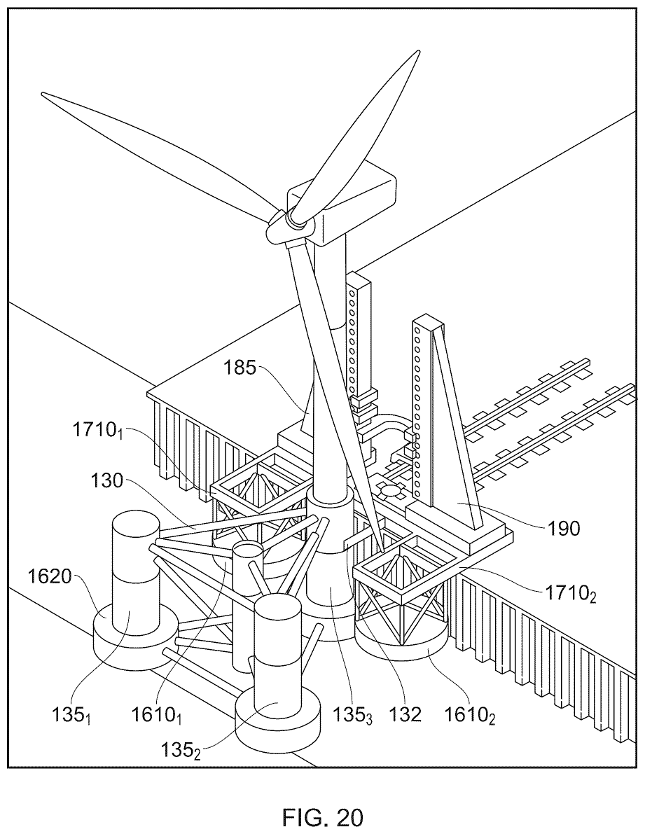

FIG. 20 illustrates moving a jacking rig from a position overhanging a quayside onto a quayside;

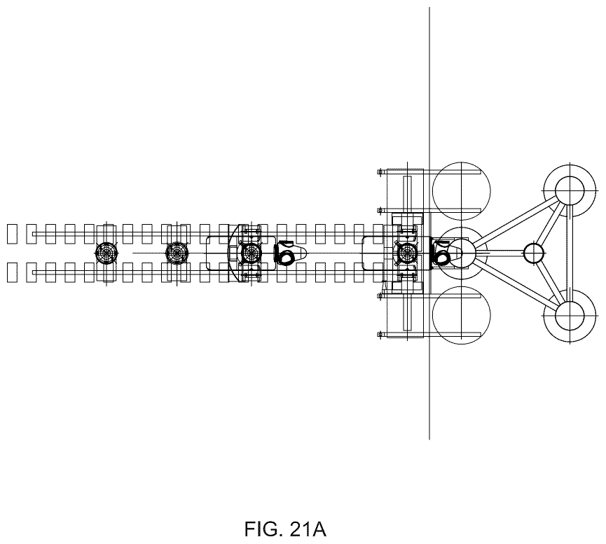

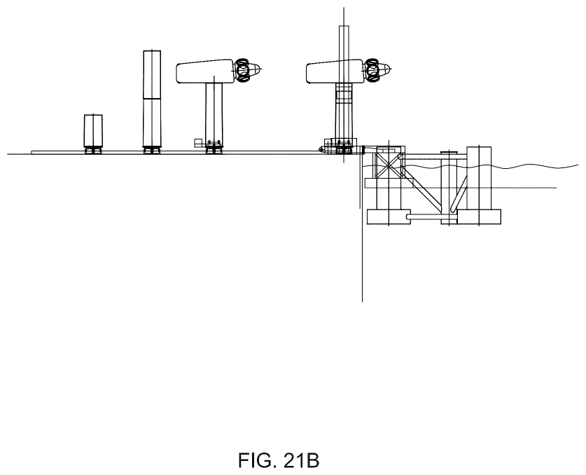

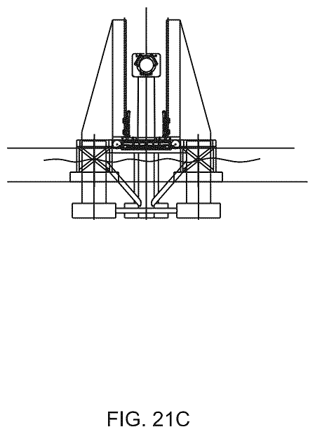

FIG. 21A, FIG. 21B, FIG. 21C illustrate moving an upper tower section of a wind turbine in line drawing form with three different views;

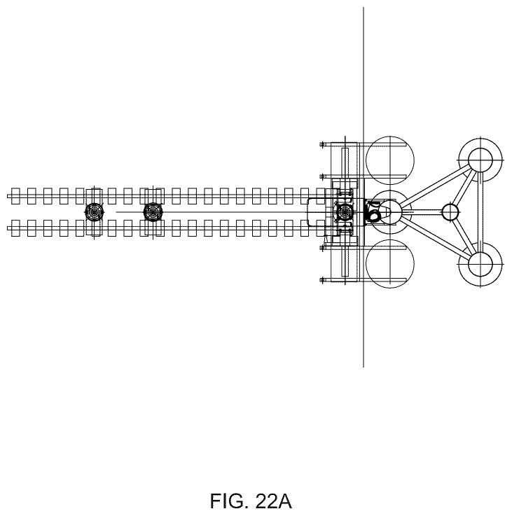

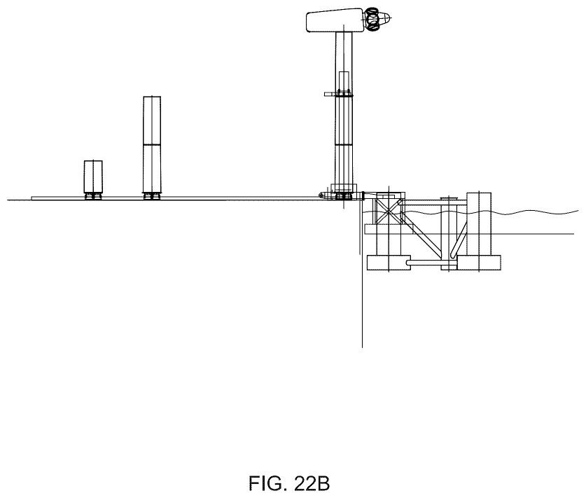

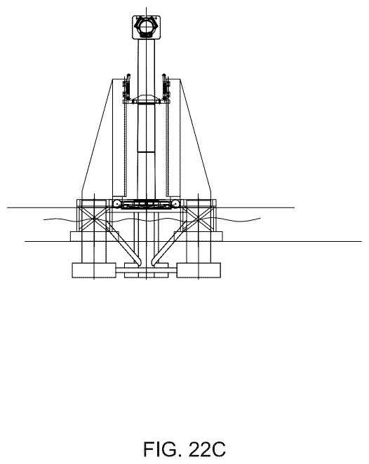

FIG. 22A, FIG. 22B, FIG. 22C illustrate installing an intermediate tower section of a wind turbine in line drawing form with three different views;

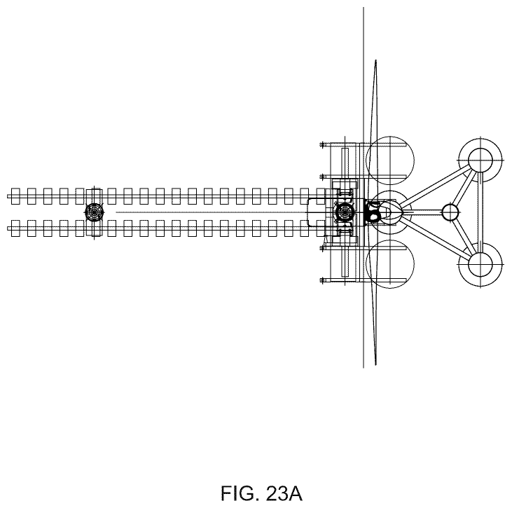

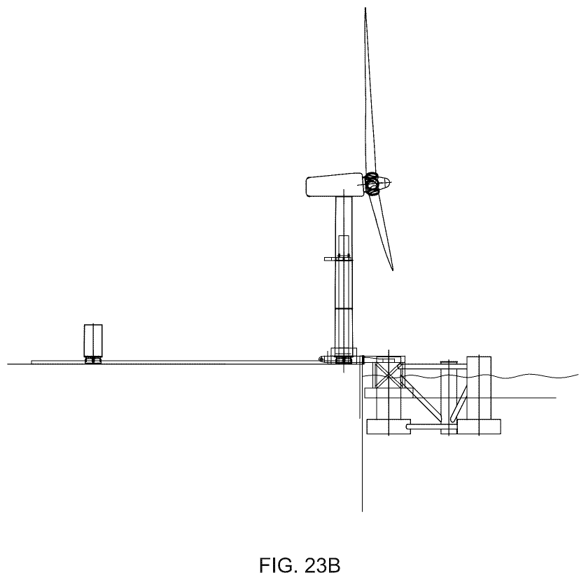

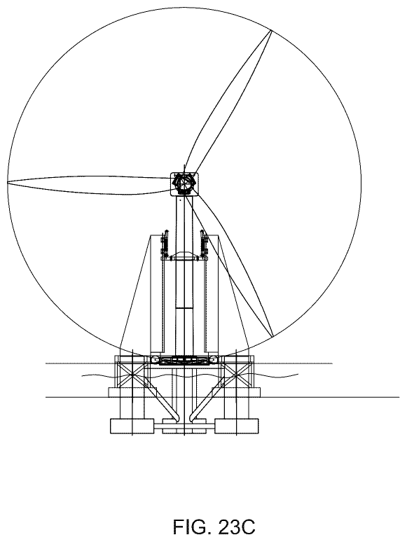

FIG. 23A, FIG. 23B, FIG. 23C illustrate using a land-based crane to install wind turbine blades in line drawing form with three different views;

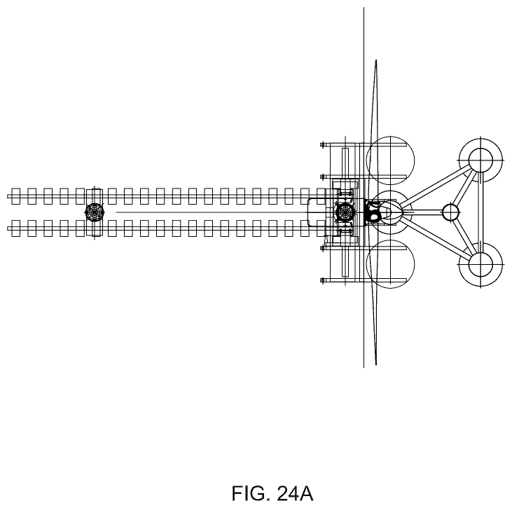

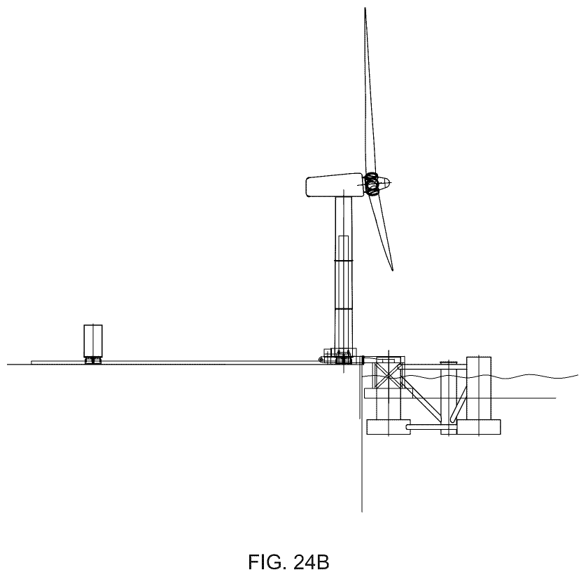

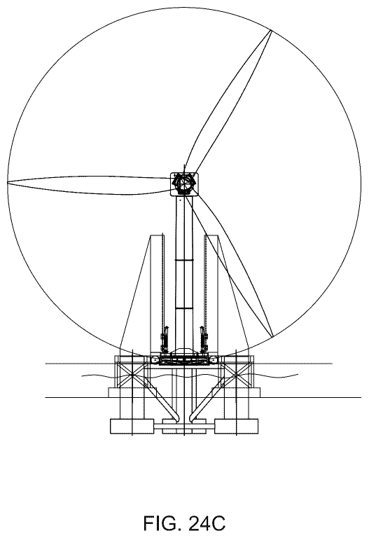

FIG. 24A, FIG. 24B, FIG. 24C illustrate adjusting grip of jacking rig on a partially-assembled wind turbine in line drawing form with three different views;

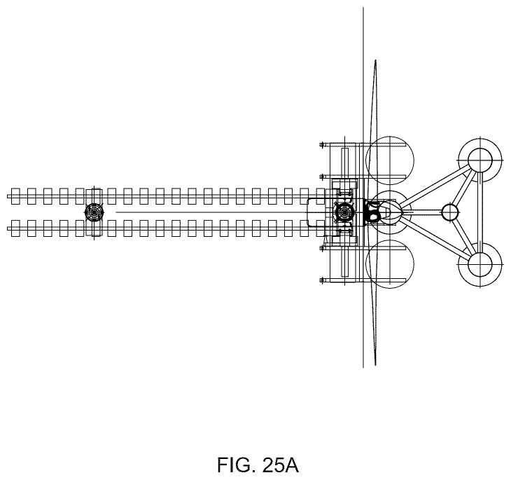

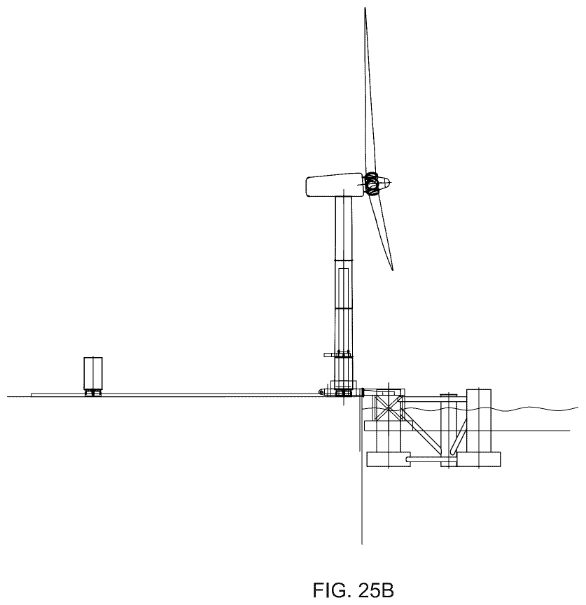

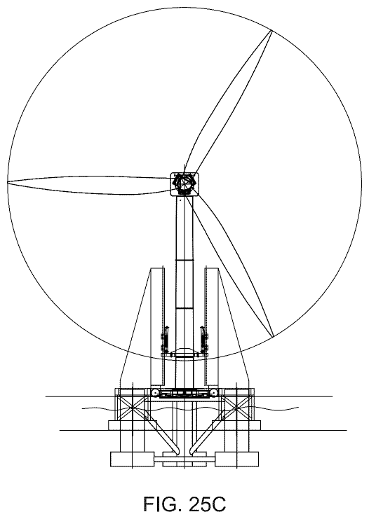

FIG. 25A, FIG. 25B, FIG. 25C illustrate raising a partially-assembled wind turbine using a jacking rig in line drawing form with three different views;

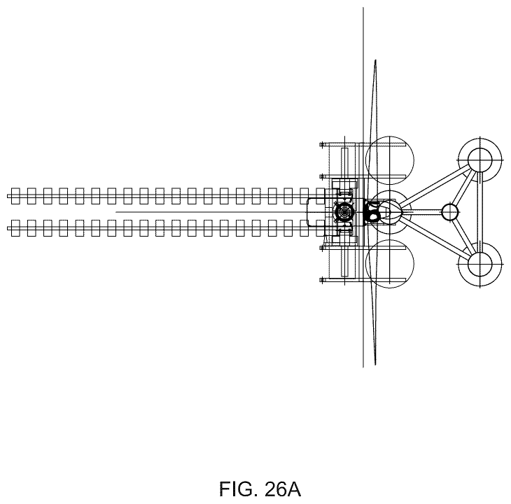

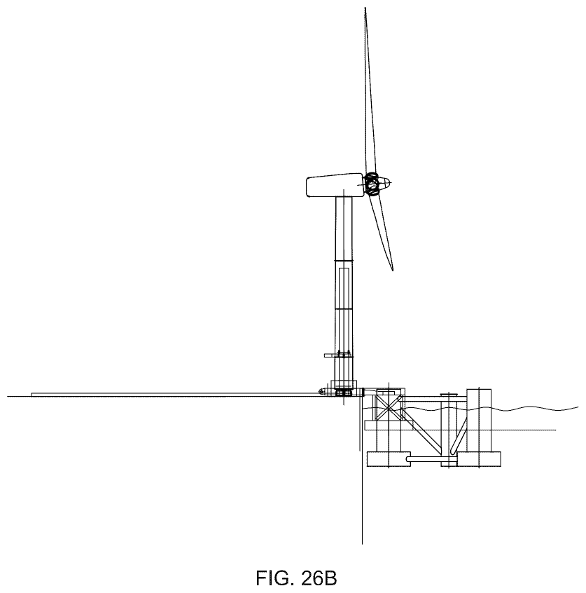

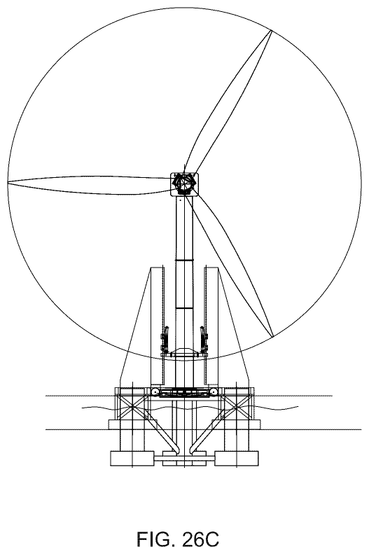

FIG. 26A, FIG. 26B, FIG. 26C illustrate installing a lower tower section of a wind turbine in line drawing form with three different views;

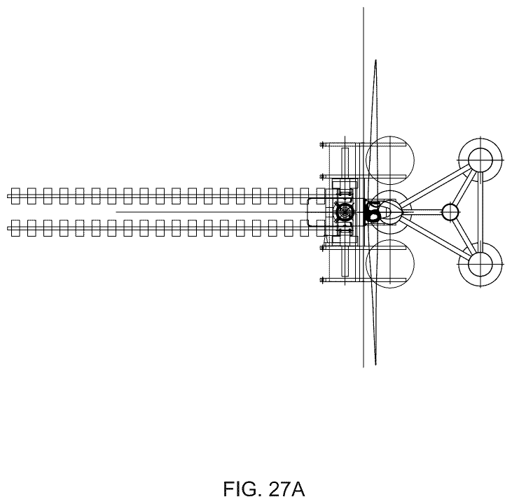

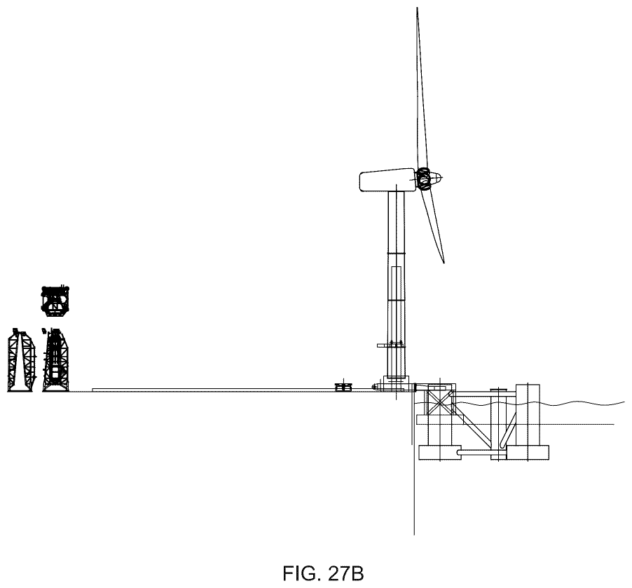

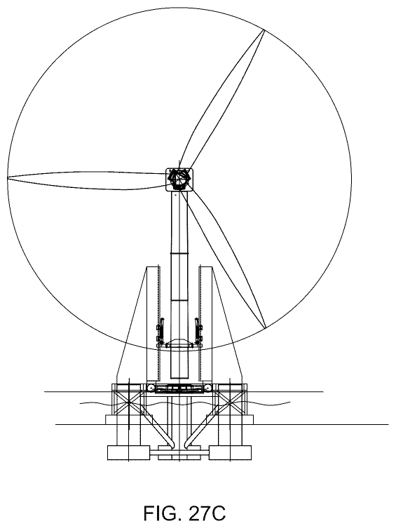

FIG. 27A, FIG. 27B, FIG. 27C illustrate raising a wind turbine using a jacking rig and removing a skid frame in line drawing form with three different views;

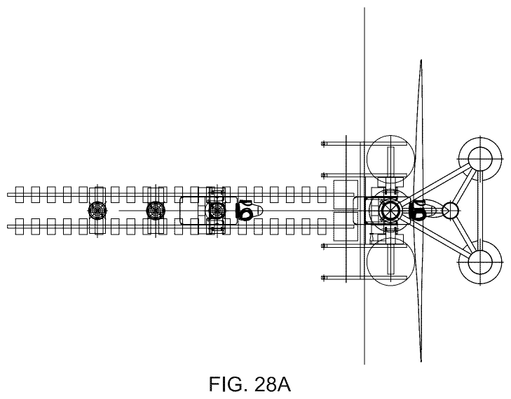

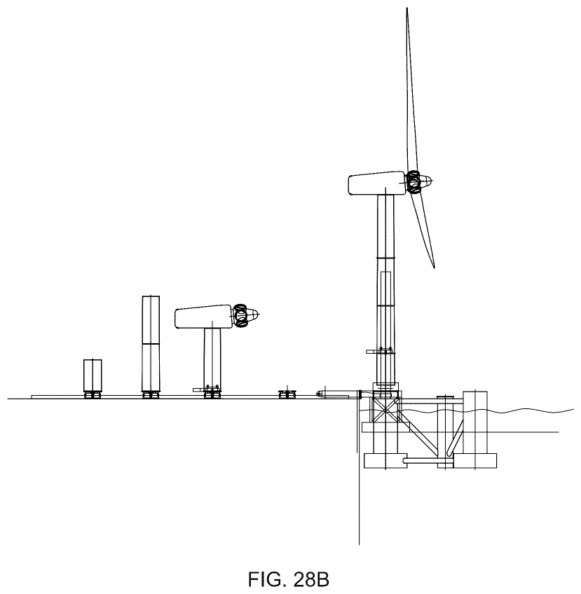

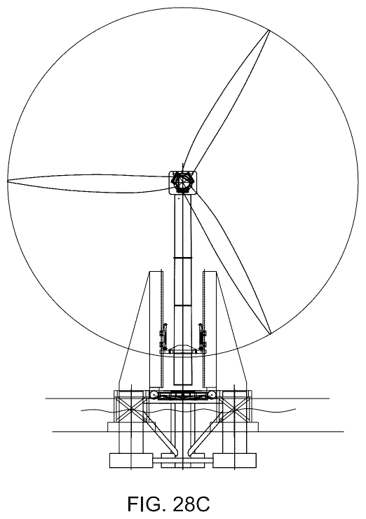

FIG. 28A, FIG. 28B, FIG. 28C illustrate moving a wind turbine using a jacking rig and a skid frame onto a floating platform in line drawing form with three different views;

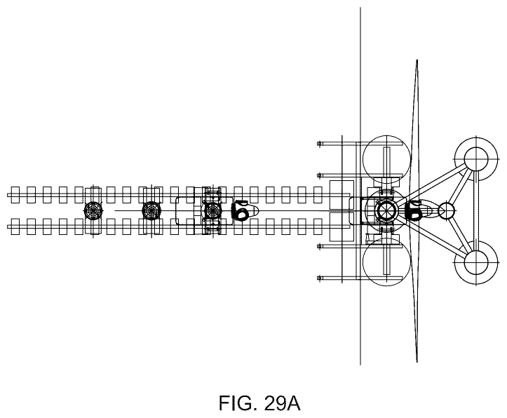

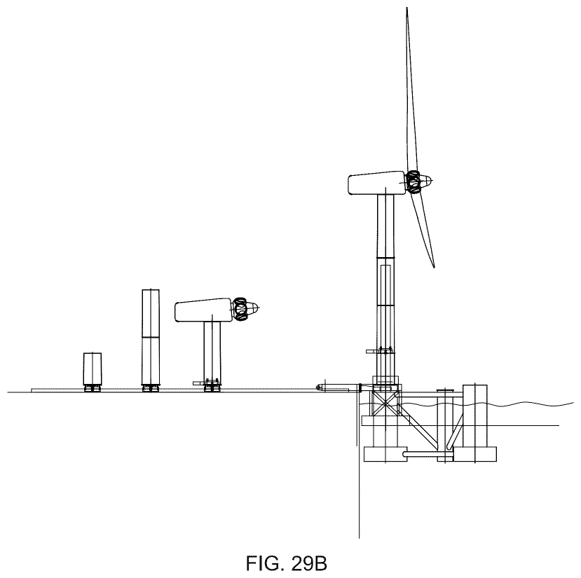

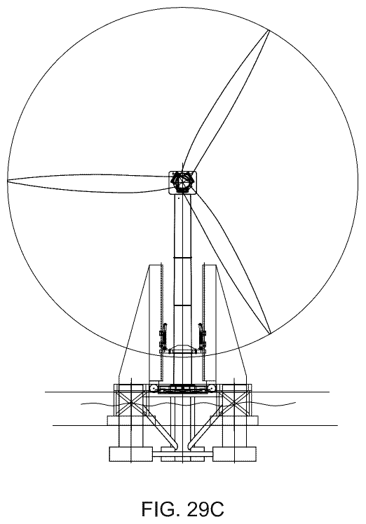

FIG. 29A, FIG. 29B, FIG. 29C illustrate installing a wind turbine onto a floating platform in line drawing form with three different views;

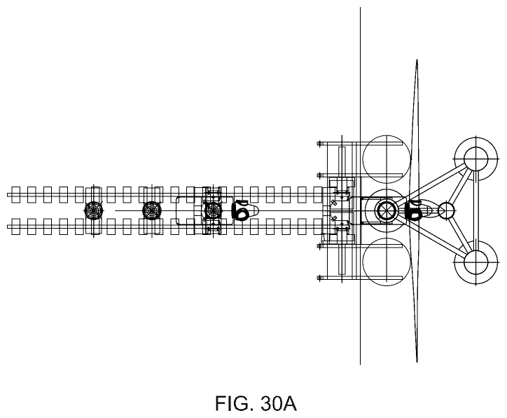

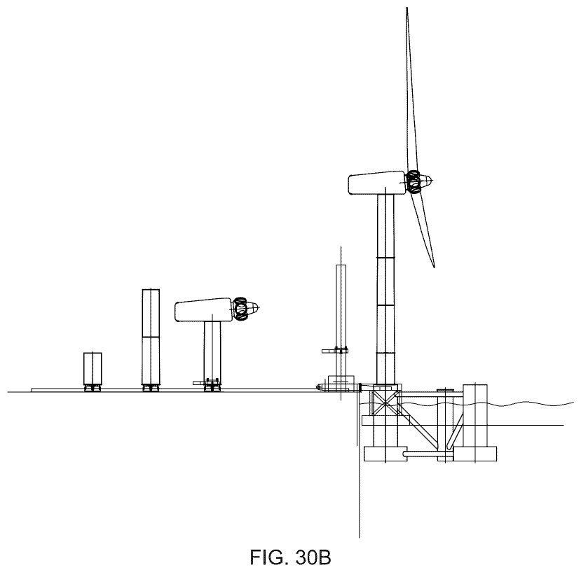

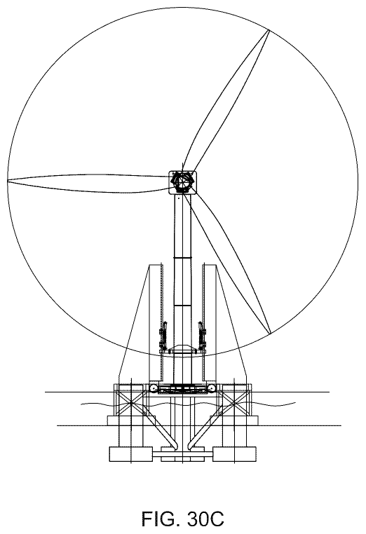

FIG. 30A, FIG. 30B, FIG. 30C illustrate moving a jacking rig onto a quayside in line drawing form with three different views;

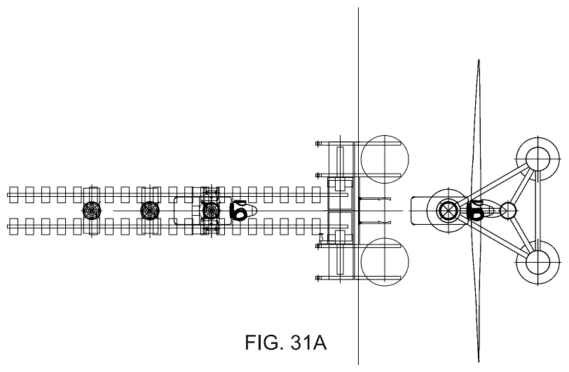

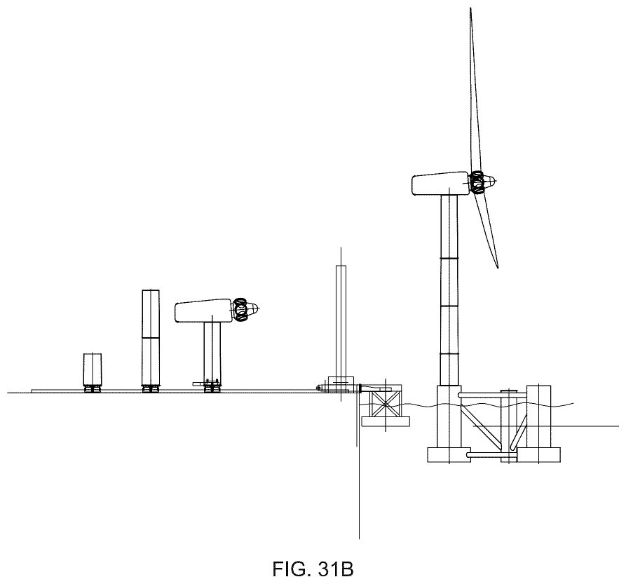

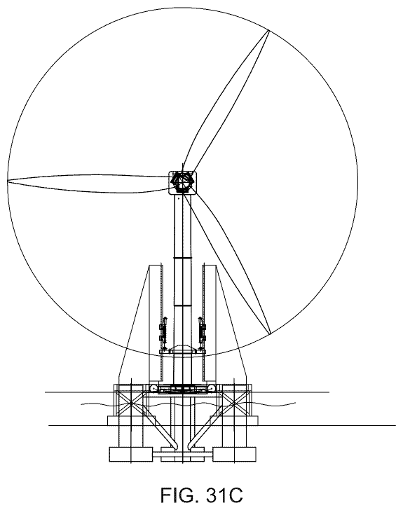

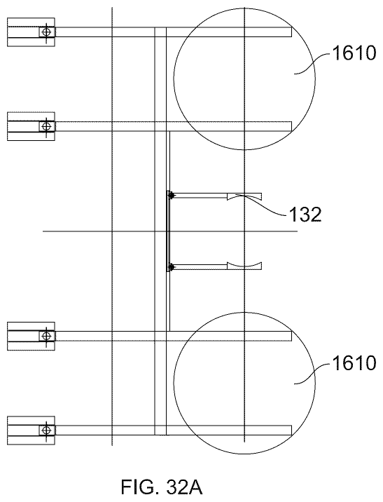

FIG. 31A, FIG. 31B, FIG. 31C illustrate releasing a floating platform and towing away in line drawing form with three different views;

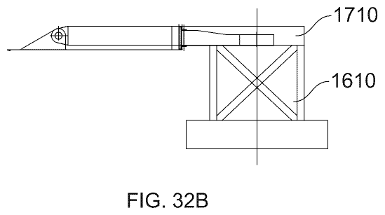

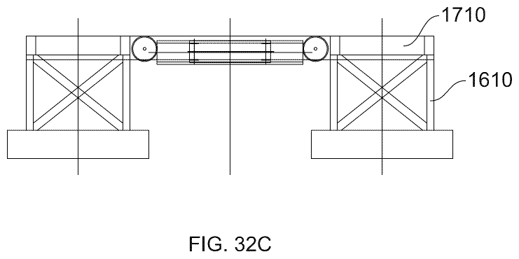

FIG. 32A, FIG. 32B, FIG. 32C illustrate a floating support rail and quayside gripper in line drawing form with three different views;

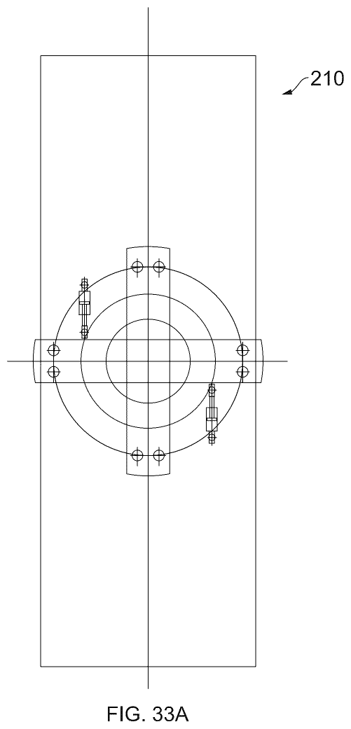

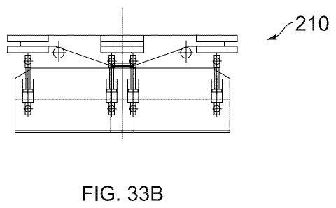

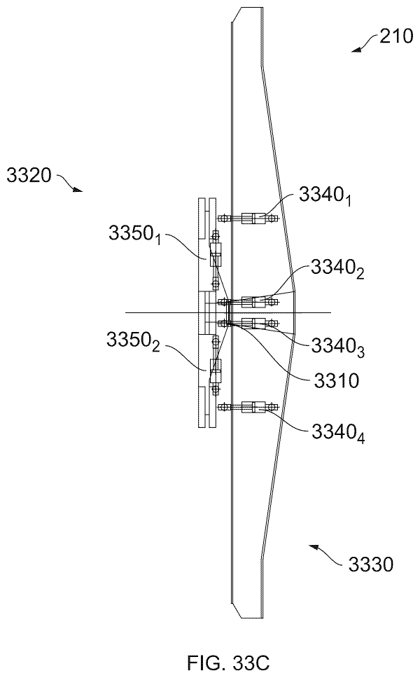

FIG. 33A, FIG. 33B, FIG. 33C illustrate a skidding frame in line drawing form with three different views;

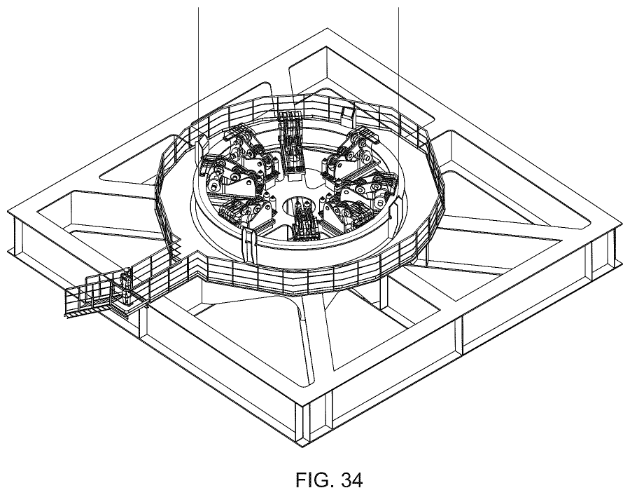

FIG. 34 illustrates a 3-dimensional diagram of a skidding frame;

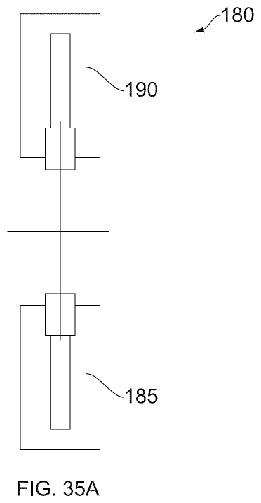

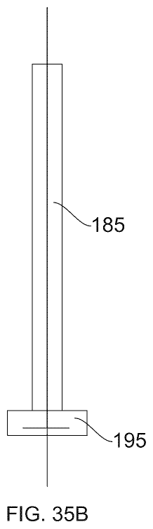

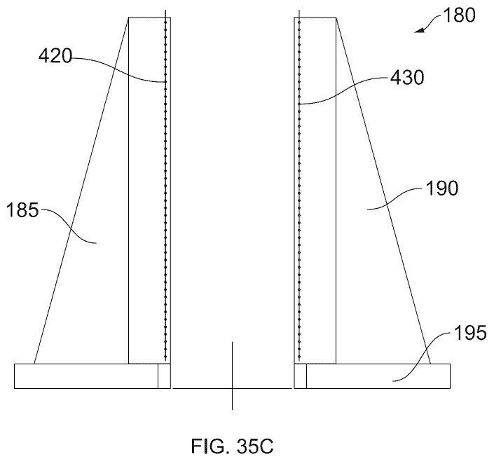

FIG. 35A, FIG. 35B, FIG. 35C illustrate a jacking rig in line drawing form with three different views;

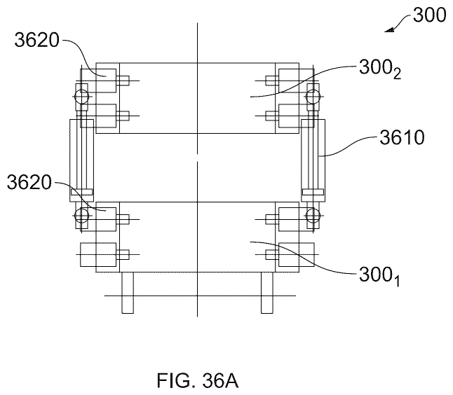

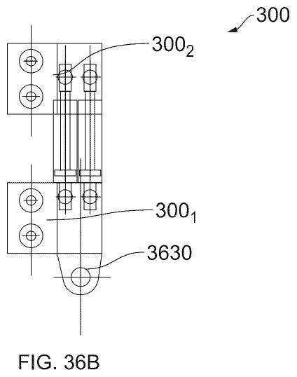

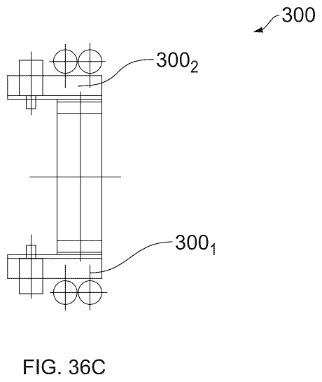

FIG. 36A, FIG. 36B, FIG. 36C illustrate climbing elements in line drawing form with three different views;

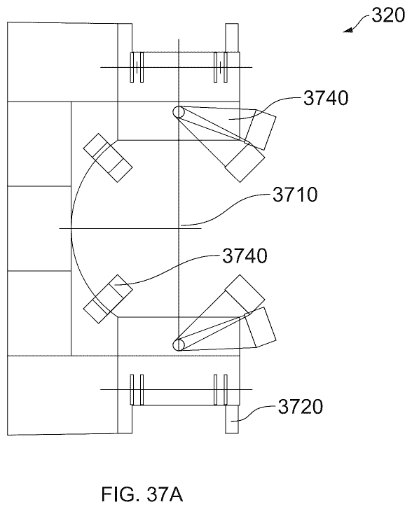

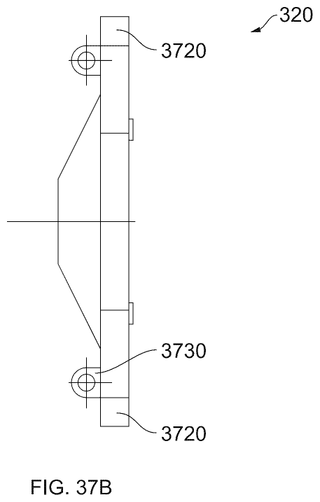

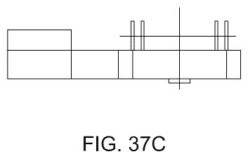

FIG. 37A, FIG. 37B, FIG. 37C illustrate a lift beam of a jacking rig in line drawing form with three different views;

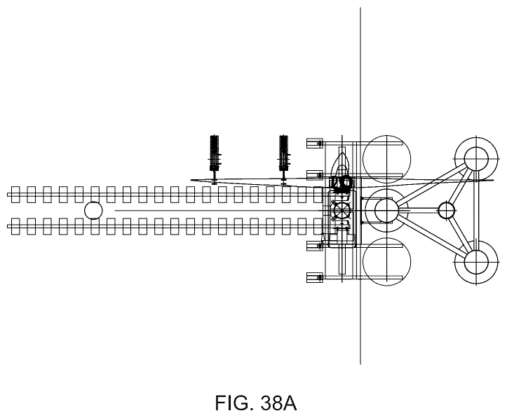

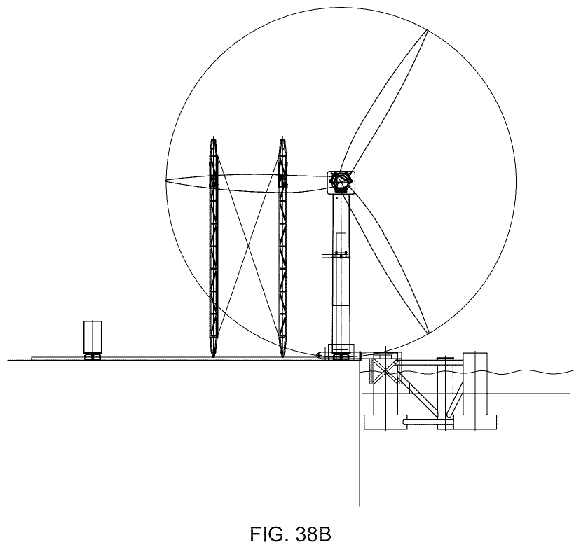

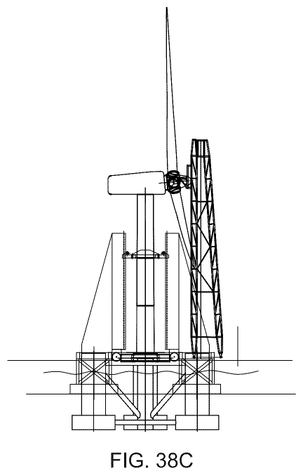

FIG. 38A, FIG. 38B, FIG. 38C illustrate an alternative installation of wind turbine blades using a blade guide in line drawing form with three different views;

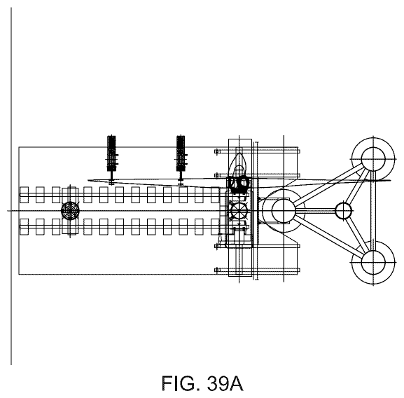

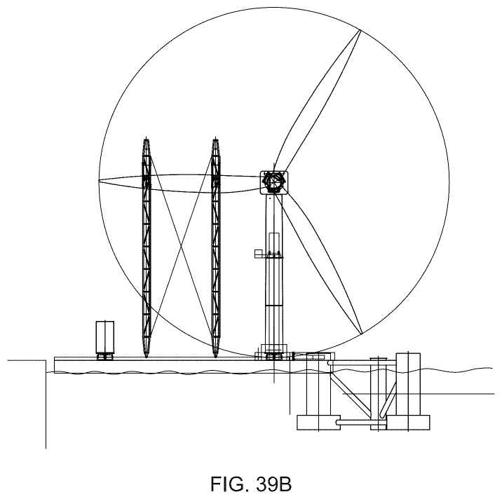

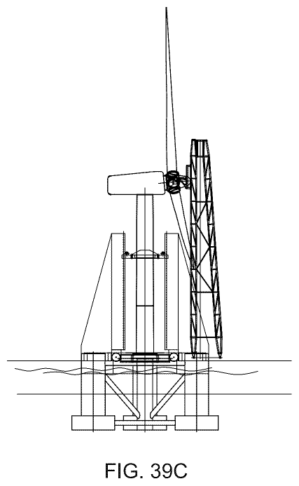

FIG. 39A, FIG. 39B, FIG. 39C illustrate an alternative installation of wind turbine blades using a blade guide on a floating vessel in line drawing form with three different views;

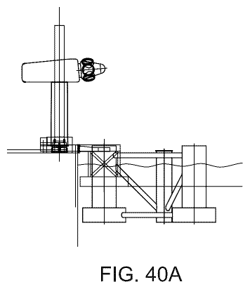

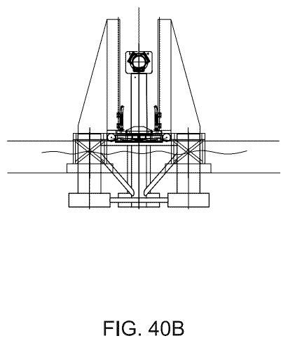

FIG. 40A, FIG. 40B illustrate an alternative to climbing elements for raising and lowering a lift beam of a jacking rig in line drawing form with two different views;

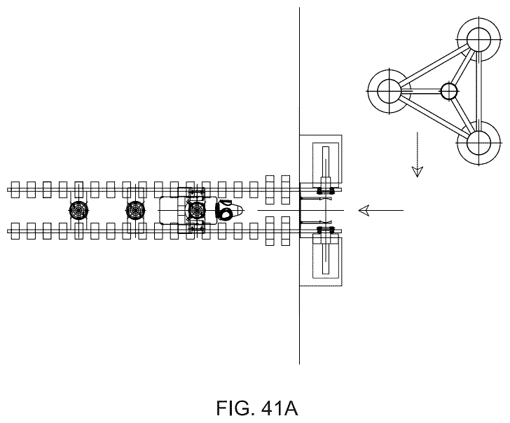

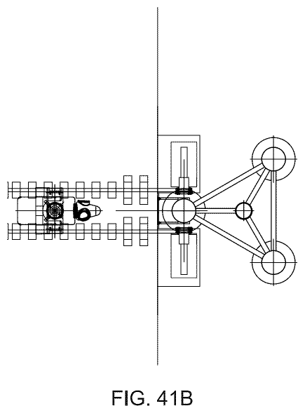

FIG. 41A, FIG. 41B illustrate an alternative assembly of a wind turbine and installation onto a floating platform whereby the assembly may take place on overhanging supports in line drawing form with two different views; and

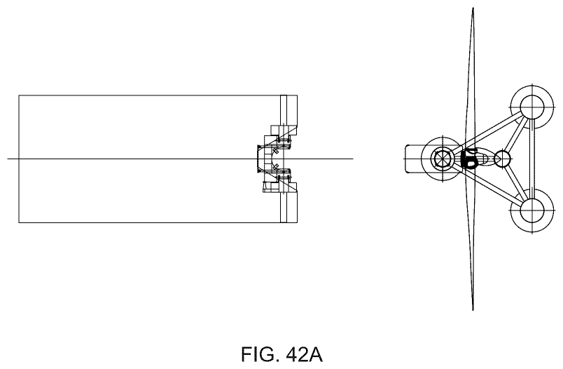

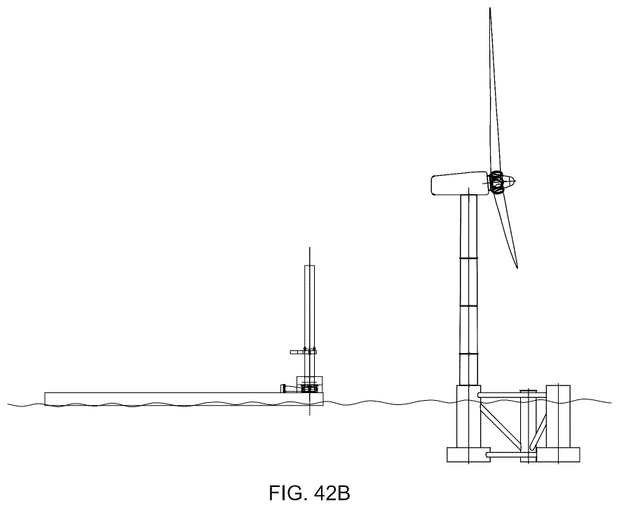

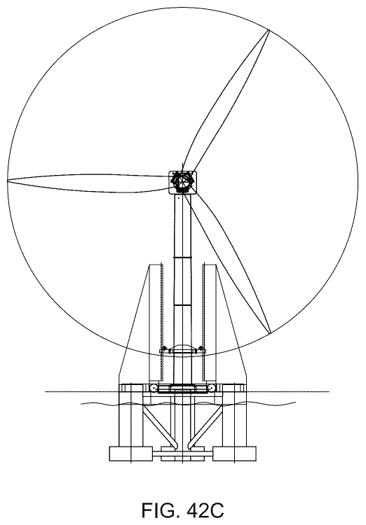

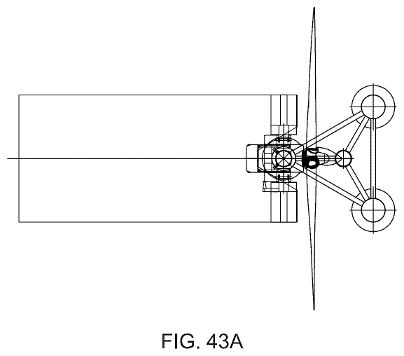

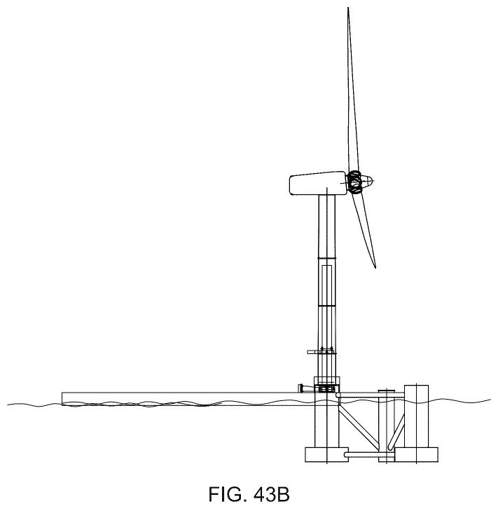

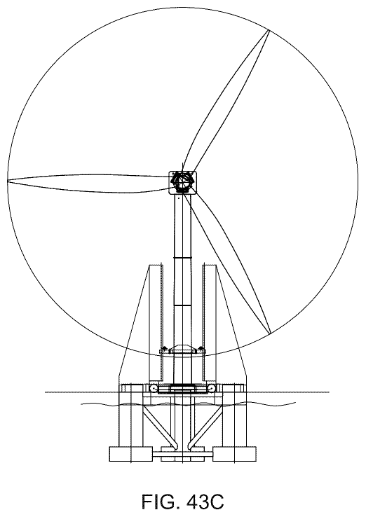

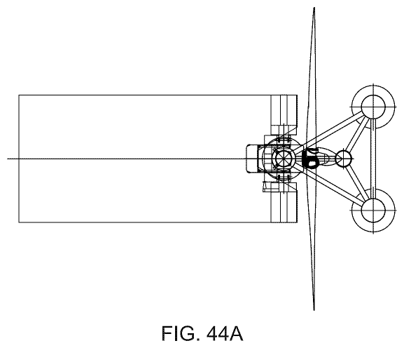

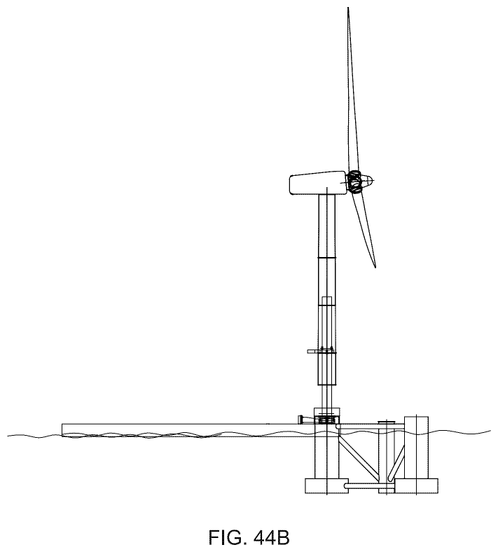

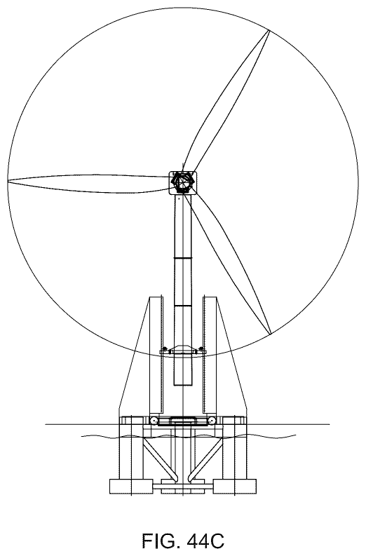

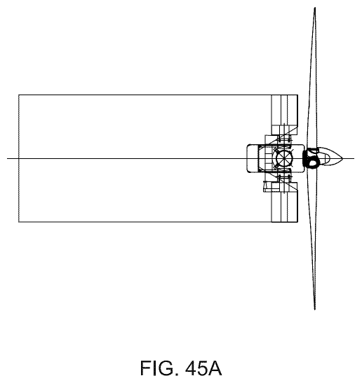

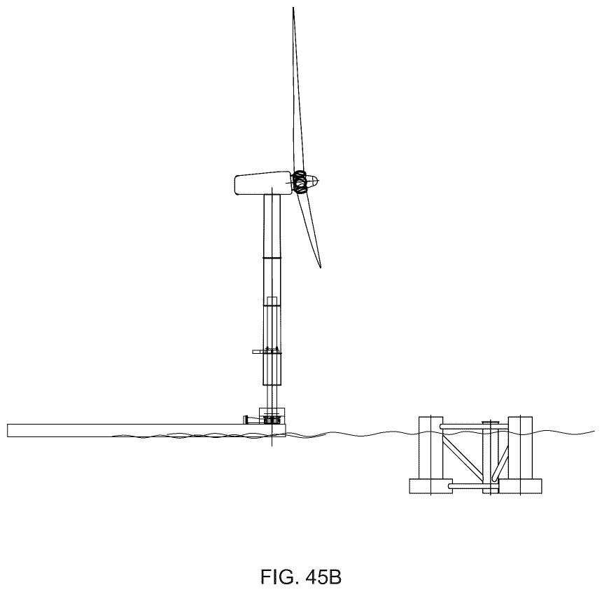

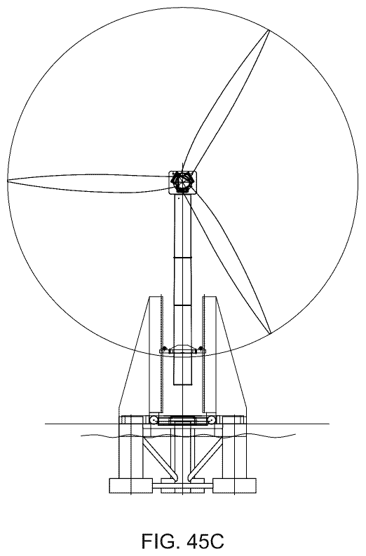

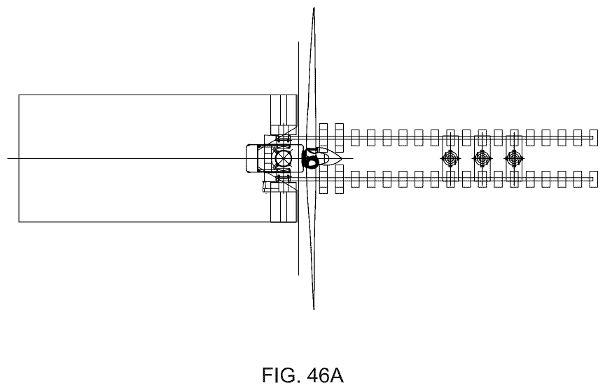

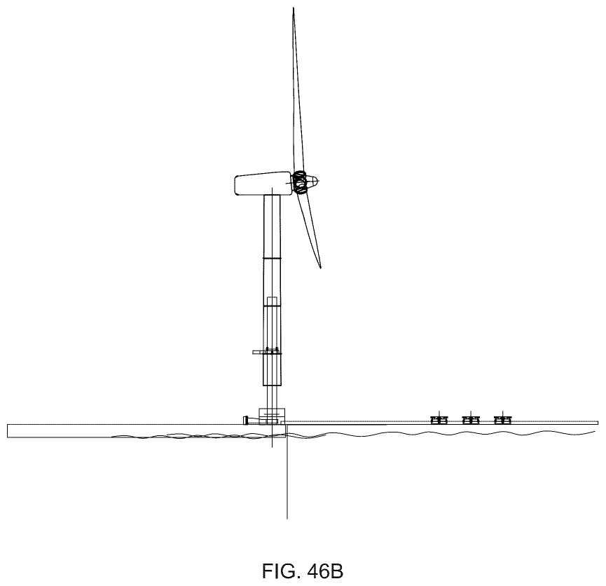

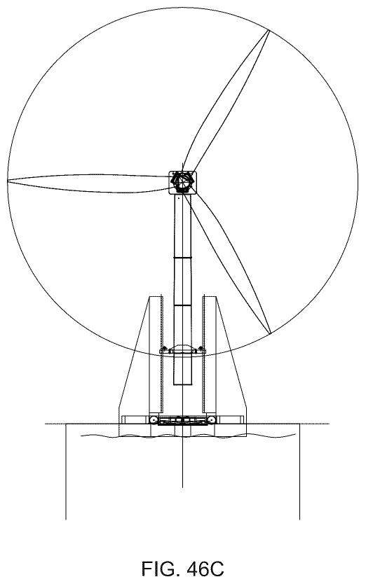

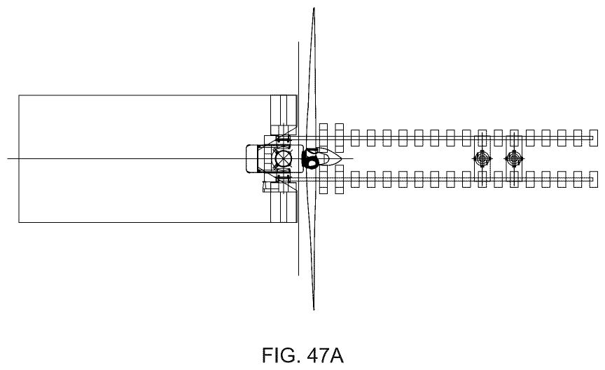

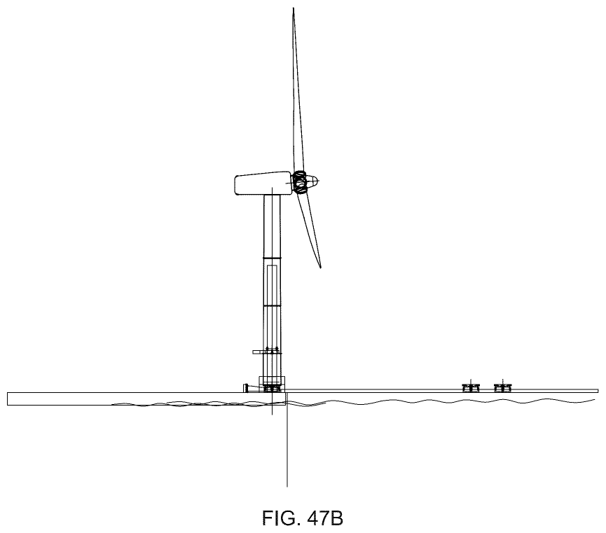

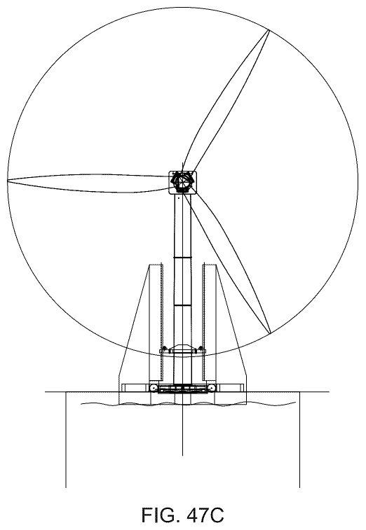

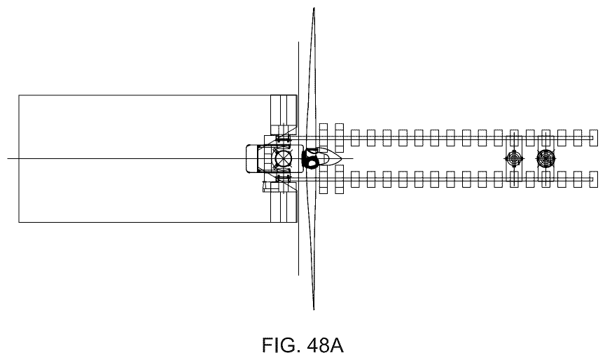

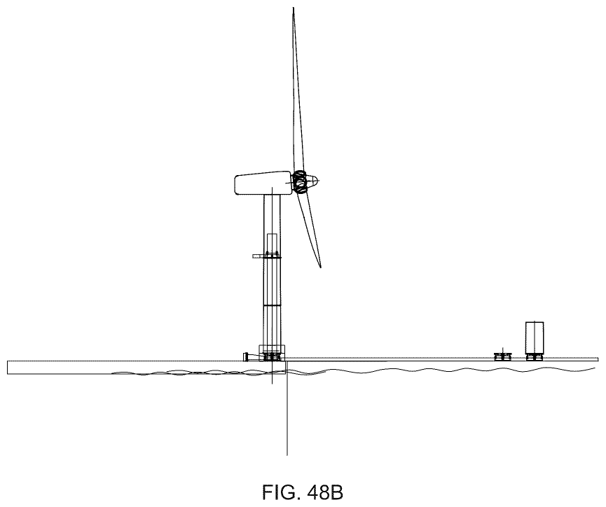

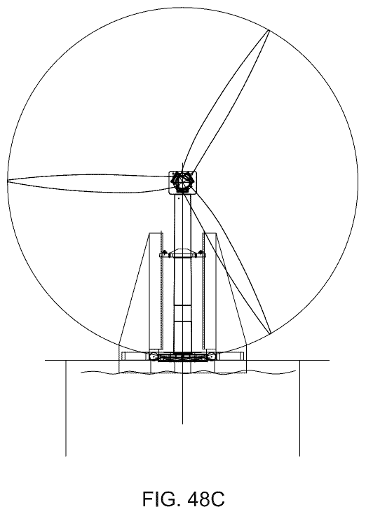

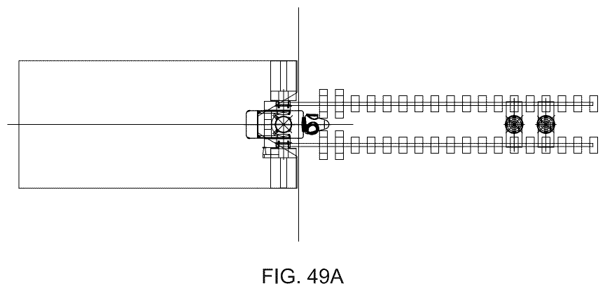

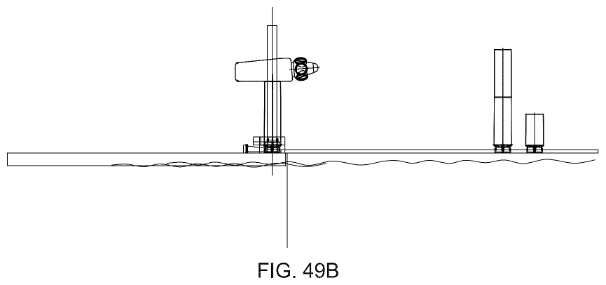

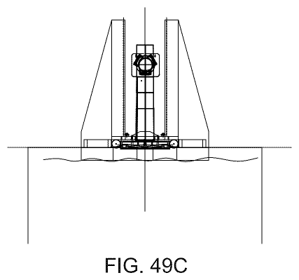

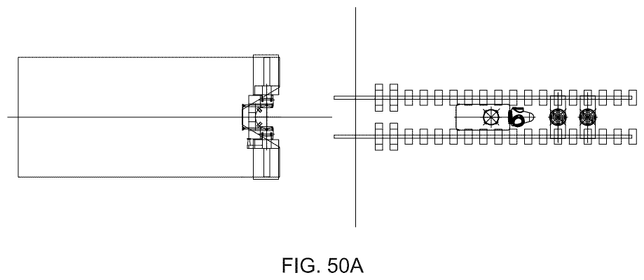

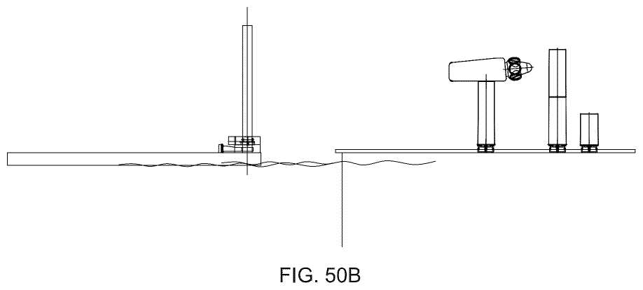

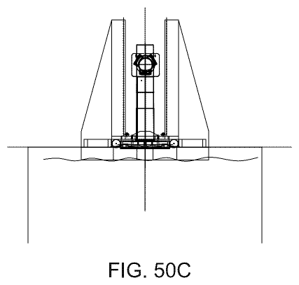

FIGS. 42-50 illustrate an alternative assembly/disassembly of a wind turbine whereby the assembly takes places on a floating vessel in line drawing form with three different views A, B, C for each Figure.

In the drawings like reference numerals refer to like parts.
FIG. 1 illustrates a quayside environment 100. Whilst a quayside region 110 is illustrated in FIG. 1 it will be appreciated that certain embodiments of the invention are otherwise applicable to land regions which are immediately proximate to a body of water 105. The body of water 105 illustrated in FIG. 1 is a body of seawater. As illustrated in FIG. 1 the quayside region 110 includes an upper surface 115 which is substantially flat and rigid and which can support load bearing structures. An edge 120 of the quayside region shown includes strengthening elements in the form of piles driven into the ground.

Whilst a land region and adjacent body of water are shown in FIG. 1 it will be appreciated that according to certain other embodiments of the present invention a floating region such as that provided by a surface on a floating vessel such as a barge or the like could likewise be utilised to provide an upper surface that is substantially flat and rigid and that can support load bearing structures. The edge of the barge on a portside or starboard side or a front or back of the barge or floating vessel can be utilised to provide an edge region adjacent to the body of water in which the floating vessel floats for assembly purposes.

FIG. 1 illustrates a floating platform 130 in the form of a submergible tripod platform. The floating platform has a buoyancy which can be selected by pumping air and or water in or out of the various parts of the platform. The floating platform 130 is held in position by a platform mount 132. The platform mount 132 includes two parallel bars and a connecting plate. It will be appreciated that the floating platform 130 may alternatively be held in position using a different method. The platform mount 132 may also be referred to as a quayside gripper. The quayside gripper is an example of a gripper member. As illustrated in FIG. 1 the floating platform includes three primary legs 135₁, 135₂, 135₃ and in FIG. 1 each primary leg 135 is illustrated partially submerged. That is to say below a water surface level.

The floating platform 130 illustrated in FIG. 1 is an example of a floating platform that can be moved from the quayside region out to a location offshore where a wind turbine can be deployed in a wind farm scenario. The platform can be tethered and/or moored and/or anchored via conventional means at a desired location. Whilst a tripod floating platform is illustrated in FIG. 1 it will be appreciated that certain other embodiments of the present invention are applicable to the mounting of a wind turbine tower on a variety of possible floating platforms. A floating platform may therefore be a spar based or tripod based or other type of floating platform able to support a tower and wind generator unit and associated blades in an offshore location. For example, the floating platform 130 could be a Spar Buoy, Centre Tripod, Square, or the like.

It will likewise be appreciated that while certain embodiments of the present invention relate to an offshore scenario this does not necessarily mean that the wind turbine is locatable in a sea or seawater environment. Rather freshwater bodies of water such as large lakes or reservoirs could be a site for wind turbines manufactured/assembled according to certain embodiments of the present invention.

It will likewise be appreciated that while certain embodiments of the present invention relate to land-based construction/assembly/decommissioning where an elongate element such as a wind turbine portion is to be assembled.

FIG. 1 helps illustrate how an upper tower section 140 which includes a nacelle 142 and tower section can be located on the quayside. The tower shown has a generally cylindrical shaft-like configuration but the invention is applicable to the erection of other elongate structural sections. The nacelle is secured in a swivelable configuration near the upper tower section 145 top. The upper town section 140 also includes a hub 143 onto which wind turbine blades may be secured. A skiddable carriage (not shown in FIG. 1) runs along a section of track 150 which is securely mounted onto the quayside region surface 110. The skiddable carriage may be referred to as a lower skidding frame. The lower skidding frame can thus be moved along the track 150 to laterally move the upper tower section and Nacelle mounted to it towards or away from the body of water and thus the floating platform. In some examples, the lower skiddable carriage may run on sliding bearings on the track 150. The lower skiddable carriage (as may be shown in FIGS. 33, 34 or the like) has an array of internal flange clamps. The upper tower section 140 may include a bottom flange (not shown). The internal flange clamps of the lower skiddable carriage may secure to the bottom flange of the upper tower section 140. The internal flange clamps may help to locate the upper tower section 140. Optionally the internal flange clamps may help to provide moment carrying functionality, ie support a moment applied to the upper tower section 140.

FIG. 1 helps illustrate an intermediate section 155 of a tower on a respective skid 160 and a lower tower section 165 on an associated skid 170. The skids enable translation of parts to be assembled to selectively be moved independently along the tracks. They may be delivered to a reception end region of the tracks by any suitable conventional means such as by truck or by train or the like. In FIG. 1, the upper tower section 140, intermediate tower section 155, and the lower tower section 165 may be considered to be on an assembly line guided by the track 150.

It will be appreciated that the upper tower section 140 may be secured to the skid (skidding frame) 210 (shown in FIG. 2) using an internal flange grip tool. The internal flange grip tool may have sufficient capacity to resist storm force wind loading. The intermediate tower section 155 and lower section 165 may also be secured to their respective skids, 160, 170 using the internal flange grip tool.

Also illustrated in FIG. 1 is a jacking rig 180 which includes a first jacking support 185 and a further jacking support 190. The first jacking support 185 is spaced apart from and in alignment with the further jacking support 190. The jacking supports 185, 190 are rigid tower-like structures supported by foundations 195 that extend vertically upwards away from the quayside region to help lift parts as required. The first jacking support 185 is associated with a first base 195₁. The further jacking support 190 is associated with a further base 195₂. It will be appreciated that jacking is a lifting technique.

FIG. 2 illustrates a next step in an assembly process in which the upper tower section 140 with Nacelle 142 is moved to a lift position located in between the two supports 185, 190 of the jacking station 180. In other words, at the lift position, a central point of the bottom of the upper tower 140 in FIG. 2 is equidistant from the first support 185 and the further support 190. This is achieved by moving a skid 210, on which the upper tower section 140 is mounted, along the tracks 150 from an initial position to the lift position. It will be appreciated that the upper tower section 140 may be mounted to the skid using bolts, internal flange clamps, locking mechanisms, or the like. Optionally vertical loads of the wind turbine mass may be carried by the central elastomer bearing. Optionally SK Bearings—Laminated Elastomeric Bearing SKE500320906.0)3437 may be used to secure elements in the assembly process. It will be appreciated that the upper tower section 140 may be sufficiently supported on the skid 210 to help prevent the upper tower section 140 from toppling when exposed to wind. At the lift position, the upper tower section 140 is near the edge region 120 of the quayside region 110.

The following FIGS. 3-20 illustrate how a wind turbine may be assembled on a quay and installed onto a floating platform. It will be appreciated that the floating platform may be a corner tripod, Spar Buoy, Centre Tripod, Square, or the like. It will be appreciated that the wind turbine may be assembled and installed onto the floating platform using some of the steps illustrated in FIGS. 3-20 , by replacing some steps with alternatives including but not limited to those outlined below, or any combination. It will be appreciated that the FIGS. 3-20 could also illustrate how the wind turbine could be assembled on a floating vessel, ship, platform, or the like, and installed onto a floating platform. It will also be appreciated that the FIGS. 3-20 could illustrate, by applying the steps in reverse, how to disassemble a fully assembled wind turbine. Disassembly of the fully assembled wind turbined could be used for repair, removal, or the like. Subsequent of reconstruction and redeployment can likewise be facilitated.

FIG. 3 illustrates how lift points 300 on the first jacking station support 185 and associated lift points 310 on the opposed upright jacking station support 190 are secured to the upper tower section 140 of the tower of the wind turbine via a lift beam 320. The lift beam may be secured to the upper tower section 140 using gripper elements, bolts, or the like. It will be appreciated that sometimes, the lift points may be referred to as climbing elements.

The climbing elements 300 include a lower climbing element 300₁ and an upper climbing element 300₂. It will be appreciated that the climbing elements 300_{1,2} may be collectively referred to as a climber system. The climbing elements 300_{1,2} include a protruding arm on either end of a central plate. In FIG. 3, the climbing elements 300 are attached by spring-loaded engagement pins in the protruding arms to the first jacking support 185. That is to say the pins of the climbing elements 300 are by default engaged with the first jacking support 185. The spring-loaded engagement pins may be disengaged using hydraulics to resist the spring tension. The climbing elements 310 include a lower climbing element 310₁ and an upper climbing element 310₂. It will be appreciated that the climbing elements 310_{1,2} may be collectively referred to as a climber system. The climbing elements 310_{1,2} include a protruding arm on either end of a central plate. The climbing elements 310 are attached by spring-loaded engagement pins in the protruding arms to the further jacking support 190. That is to say the pins of the climbing elements 310 are by default engaged with the further jacking support 190. The spring-loaded engagement pins may be disengaged using hydraulics to resist the spring tension. It will be appreciated that sometimes, the climbing elements 300, 310 may be attached to the jacking rig 180 using clips, clamps, or any other securing mechanism. The lower climbing element 300₁ is connected to the upper climbing element 300₂ by a pair of vertically arranged hydraulic cylinders. That is to say a gap between the lower climbing element 300₁ and the upper climbing element 300₂ may be selectively increased by actuating the hydraulic cylinders attached to the climbing elements 300_{1,2}. It will be appreciated that any number of hydraulic cylinders may be used to change the gap between the climbing elements 300_{1,2}. Similarly, the lower climbing element 310₁ is connected to the upper climbing element 310₂ by a pair of vertically arranged hydraulic cylinders. That is to say a gap between the lower climbing element 310₁ and the upper climbing element 310₂ may be selectively increased by actuating the hydraulic cylinders attached to the climbing elements 310_{1,2}. It will be appreciated that any number of hydraulic cylinders may be used to change the gap between the climbing elements 310_{1,2}. Repeatedly increasing and decreasing the distance between the spaced apart climber elements helps the elements rise or lower whilst supporting load and resisting moments imparted by the lifted portion of the WT.

The lift beam 320 is secured to the climbing elements 300, 310. The lift beam in FIG. 3 has an arc shape, although it will be appreciated that alternative shapes of lift beam could be used. The centre axis of the arc of the lift beam 320 is in the same axis as the lift position of the jacking rig 180. The lift beam 320 may be secured to the climbing elements 300, 310 using pins, bolts, clamps, or the like. The lift beam 320 has a series of tower grippers (not shown). The tower grippers engage with features on the tower sections 140, 155, 165, or the like thereby helping to transfer a weight of the tower sections to the jacking rig 180. The tower grippers may also help to transfer a bending moment from the tower sections to the jacking rig 180. It will be appreciated that certain embodiments may feature more than 1 lift beam which may be separated vertically and independently engaged with the tower sections at suitable locations such as other tower flanges to help react at least part of the moments from the tower as coupled forces.

Once the upper tower section 140 is secured to the jacking rig 180 via the lift beam 320 and climbing elements 300, 310, the securing elements which secured the upper tower section 140 to the skid 210 may be removed. In other words, in FIG. 3, the skid 210 is disconnected from the upper tower section 140 so that the skid and upper tower section may move independently.

FIG. 4 illustrates a lift process and illustrates how the jacking station and climbing elements connected to the respective jacking supports can be driven to urge the upper tower section 140 and associated nacelle 142 into a first elevated position. Also in FIG. 4, the array of internal flange clamps 410 described in FIG. 1 in respect of the skiddable carriage can be seen. FIG. 4 helps illustrate how the skid 210 of the first tower section can be left behind when the upper tower section 140 is raised. Optionally the upper tower section 140 is raised by at least 1, 5, 10, 20 or 30, or the like metres. The first jacking support 185 has a vertical series of holes 420 on a water-side face and a quayside face near an edge of a longest side of the first jacking support 185. The further jacking support 190 has a corresponding vertical series of holes 430. The vertical series of holes 420 are in alignment with the corresponding vertical series of holes 430. That is to say for every hole in the first jacking support 185 there may be a corresponding hole at a same elevation in the further jacking support 190. Optionally the holes 420, 430 may not be in alignment. Optionally all holes may be on 1 or more supports and support the climber/hoisting units and lifting beam in a cantilevered fashion.

The upper tower section 140 is lifted from a ground position (as shown in FIG. 3) to the first elevated position by the climbing elements 300, 310. The lower climbing element 300₁ is attached towards one end of the lift beam 320 by a pair of pins. Similarly, the other lower climbing element 310₁ is attached towards another end of the lift beam 320 by a pair of pins. It will be appreciated that more than two pins could be used, or alternatively, the lower climbing elements 300₁, 310₁ could be secured to the lift beam using bolts, clamps, or the like. Starting from when the lower climbing elements 300₁, 310₁ are secured, the climber systems (upper and lower climbing elements collectively) climb the first jacking support 185 and further jacking support 190 synchronously as follows.

The spring-loaded pins in the lower climbing elements 300₁, 310₁ are extended into the vertical holes 420, 430 and the spring-loaded pins in the upper climbing elements 300₂, 310₂ are retracted from the vertical holes 420, 430 of the corresponding first and further jacking support 185, 190. That is to say the spring-loaded pins in the lower climbing element 300₁ are extended into the vertical holes 420 of the first jacking support 185, and the spring-loaded pins in the corresponding lower climbing element 310₁ are also extended into the vertical holes 430 of the further jacking support 190; and the spring-loaded pins in the upper climbing element 300₂ are retracted from the vertical holes 420 of the first jacking support 185, and the spring-loaded pins in the corresponding upper climbing element 310₂ are also retracted from the vertical holes 430 of the further jacking support 190. Next, the pair of vertically arranged hydraulic cylinders that connect the lower climbing element 300₁ to the upper climbing element 300₂ associated with the first jacking support 185 are extended at the same time as the corresponding hydraulic cylinders that connect the corresponding lower climbing element 310₁ to the corresponding upper climbing element 310₂ associated with the further jacking support 190 are extended. As a result, the upper climbing elements 300₂, 310₂ are guided vertically upwards along their respective jacking supports 185, 190. That is to say the upper climbing element 300₂ is guided along the long edge of the first jacking support 185 to an intermediary position along the vertical axis of the first jacking support 185; and the upper climbing element 310₂ is guided along the long edge of the further jacking support 190 to a corresponding intermediary position along the vertical axis of the further jacking support 190. Then, the spring-loaded pins in the upper climbing elements 300₂, 310₂ are extended into the vertical holes 420, 430 and the spring-loaded pins in the lower climbing elements 300₂, 310₂ are retracted from the vertical holes 420, 430 of the corresponding first and further jacking support 185, 190. That is to say the spring-loaded pins in the upper climbing element 300₂ are extended into the vertical holes 420 of the first jacking support 185, and the spring-loaded pins in the corresponding upper climbing element 310₂ are also extended into the vertical holes 430 of the further jacking support 190; and the spring-loaded pins in the lower climbing element 300₁ are retracted from the vertical holes 420 of the first jacking support 185, and the spring-loaded pins in the corresponding lower climbing element 310₁ are also retracted from the vertical holes 430 of the further jacking support 190. Next, the pair of vertically arranged hydraulic cylinders that connect the lower climbing element 300₁ to the upper climbing element 300₂ associated with the first jacking support 185 are retracted at the same time as the corresponding hydraulic cylinders that connect the corresponding lower climbing element 310₁ to the corresponding upper climbing element 310₂ associated with the further jacking support 190 are retracted. As a result, the lower climbing elements 300₁, 310₁ are guided vertically upwards along their respective jacking supports 185, 190. That is to say the lower climbing element 300₁ is guided along the long edge of the first jacking support 185 to another position along the vertical axis of the first jacking support 185; and the lower climbing element 310₁ is guided along the long edge of the further jacking support 190 to a corresponding position along the vertical axis of the further jacking support 190. The process is then repeated such that the spring-loaded pins of the lower climbing elements 300₁, 310₁ are again extended into the holes 420, 430 of the corresponding jacking support 185, 190 as required to reach a desired elevation. Once the desired elevation is reached, the lift beam 320 may optionally extend a lift beam guide element into the holes 420 of the first jacking support 185 and into the holes 430 of the further jacking support 430. The lift beam guide elements may provide additional support by transferring either of the weight and the bending moment of the upper tower section 140 from the lift beam 320 directly to the jacking supports 185, 190.

In this fashion, the lift beam 320, which may be secured to the climbing elements 300, 310, is elevated (raised) vertically upwards. Correspondingly, the upper tower section 140, which may be secured to the lift beam 320, is elevated (raised) vertically upwards. In effect, the upper tower section 140 is lifted vertically away from its skid 210 until the upper tower section 140 is lifted to the first elevated position shown in FIG. 4.

FIG. 5 illustrates removal of the skid 210 which had previously been used to support and locate the upper tower section 140 and associated Nacelle 142. In FIG. 5, the upper tower section 140 is gripped by the lift beam 320, where the lift beam 320 is held in place by the climbing elements 300_{1,2}, 310_{1,2} that are attached to the holes 420, 430 in the jacking supports 185, 190. The lift beam 320 may also be supported by lift beam guide, which is extended into the holes 420, 430 on the jacking supports 185, 190.

FIG. 6 illustrates how a next skid carriage which carries the intermediate tower section 155 is then driven to the lift centre position. The intermediate section provides a midsection of a tower. It will be appreciated that certain embodiments of the present invention are useable with multi section elongate structures which may have one, two, three, four or more structural sections which need to be successively lifted and then secured to one another. In FIG. 6, the intermediate tower section 155 is moved to the lift position located in between the two supports 185, 190 of the jacking station 180. In other words, at the lift position, a central point of the bottom of the intermediate tower section 155 in FIG. 6 is equidistant from the first jacking support 185 and the further jacking support 190. This is achieved by moving the respective skid 160, on which the intermediate tower section 155 is mounted, along the tracks 150 from an initial position to the lift position. It will be appreciated that the intermediate tower section 155 may be mounted to the skid using bolts, internal flange clamps, locking mechanisms, or the like. It will be appreciated that the intermediate tower section 155 may be sufficiently supported on the skid 160 to help prevent the intermediate tower section 155 from toppling when exposed to wind. At the lift position, the intermediate tower section 155 is near the edge region 120 of the quayside region 110. In certain embodiments, at the lift position, a central point of the bottom of the intermediate tower section is not equidistant from the first jacking support and the further jacking support.

It will be appreciated that a common skid may be used to move all sections of the elongate element. That is to say when the elongate element is a wind turbine tower portion each tower section can be loaded onto the same skid, moved to a desired location and then once lifted off, the skid can be reused for the next tower section.

FIG. 7 illustrates how the upper and mid sections of a tower are joined together. In other words, the upper tower section 140 is secured to the intermediate tower section 155 by bolting and/or welding and/or clamping or the like. In FIG. 7, the bottom flange of the upper tower section 140 is secured to a top flange of the intermediate tower 155. The lift beam 320, which is still gripping the upper tower section 140, may be lowered by the climbing elements 300, 310 to lower the upper tower section 140 onto the intermediate tower section 155. Optionally, the lift beam may provide a small index rotation and translation movement of up to +/−2° of the upper tower section 155 to allow rotation alignment of the upper tower section 140 and the intermediate tower section 155.

Optionally, the indexing and alignment is to be performed by the skid (holding the intermediate tower) rather than the lift beam. Optionally there is an option to use either the lift beam or the skid to do this.

FIG. 8 illustrates the attachment of a first blade 800₁ of a wind turbine to the nacelle region of the under-construction wind turbine. The under-construction wind turbine, including the upper tower section 140, nacelle 142, and the intermediate tower section 155, are secured in position through the corresponding skid 160 and/or the grippers of the lift beam 320. The blade can be mounted to the rotor hub 143 of the nacelle 142 via a number of techniques as described hereinbelow.

Blades may be installed at a relatively low working height using a crawler crane. The crawler crane may have a fly jib. The crawler crane may have a lift height of around 125 m above the quayside, although it will be appreciated that sometimes a lift height of less than 125 m may be required. Alternatively, a lift height in excess of 125 m may be required. A crane may be used to lift the first blade 800₁ and hold the blade in position whilst the blade 800 is secured to the rotor hub 143 using bolts, locking mechanisms, or the like.

Alternatively, a rotor blade may be installed by rotating the nacelle 142 by 90 degrees and using a twin blade guide at a side of the jacking rig 180. The nacelle 142 may be rotated by rotating a portion of the skidding frame 160 that the under-construction wind turbine is mounted on. In the figure shown the tower remains fixed in terms of rotation and only the nacelle slewed on its slew bearing to a desired rotary position. A skidding frame 160 is shown in more detail in a later Figure. It will be appreciated that the grippers of the lift beam 320 will release the upper tower section 140 so that the structure may be rotated. The twin blade guide may be constructed from lightweight steel frames such as gantries, trusses, or the like. It will be appreciated that an alternative material with suitable properties may be used to construct the twin blade guide. The twin blade guide may include two pairs of guide elements. The rotor blade may be supported and lifted by the twin blade guide in a substantially horizontal position using a winch, alternative lifting system, or the like. The first blade 800₁ may be positioned close to the rotor hub 143 and thus be secured to the rotor hub using bolts, locking mechanisms, or the like. It will be appreciated that the first blade 800₁ may be positioned and secured to the rotor hub 143 using an alternative approach.

FIG. 9 illustrates the securing/attachment of a further blade 800₂ to the partially constructed wind turbine according to any of the methods described in FIG. 8 or any other method known.

FIG. 10 illustrates attachment of a third blade 800₃ to the partially constructed wind turbine. The third blade 800₃ may be positioned and secured to the partially-constructed wind turbine according to any of the methods detailed above or any other method known. It will be appreciated that whilst a three blade turbine is illustrated in the Figures so far described certain embodiments of the present invention are not so restricted but rather are applicable to one, two, three, four or more blade turbines and indeed to elongate structures generally which may indeed not include any energy from wind generating elements/blades.

FIG. 11 illustrates how after a last (third in previous drawings) blade is secured, the lift beam 320 is lowered to a lower region of the jacking station. It will be appreciated that the lift beam 320 may be a lift carriage. After the gripper of the lift beam 320 has released the upper tower section 140, the lift beam 320 may be lowered according to the reverse of the method described in FIG. 4.

FIG. 12 illustrates how after the climbing elements have been secured to a lower region of the intermediate tower section 155 the lift beam 320 can be raised which lifts the combined structural elements of the three blades 800, the nacelle 143, and the secured together upper and midsections of the wind turbine tower 140, 155 away from the skid on the tracks on the quayside to a second raised position. The intermediate tower section 155 may be lifted according to the method outlined in FIG. 4 in respect of the upper tower section. Optionally the intermediate tower section 155 is raised by at least 1, 5, 10, 20, 30, or the like metres. The skid is a carriage which can ride along the tracks selectively to deliver elements to a desired point and which can then be removed to make space for a subsequent skid being brought into position.

Once the desired elevation is reached, the lift beam 320 may optionally extend a lift beam guide element into the holes 420 of the first jacking support 185 and into the holes 430 of the further jacking support 430. The lift beam guide elements may provide additional support by transferring either of the weight and the bending moment of the upper and intermediate tower sections 140, 155 from the lift beam 320 directly to the jacking supports 185, 190.

In this fashion, the lift beam 320, which may be secured to the climbing elements 300, 310, is elevated (raised) vertically upwards. Correspondingly, the intermediate tower section 155, which may be secured to the lift beam 320, is elevated (raised) vertically upwards. In effect, the intermediate tower section 155 lifted vertically away from its skid 160 until the intermediate tower section 155 and the upper tower section 140 are lifted to the second elevated position shown in FIG. 12.

FIGS. 12 and 13 illustrate the skid that was used to deliver the intermediate section of the tower as it is removed. In FIG. 13, the skid 160 which had previously been used to support and locate the intermediate tower section 155 is removed. The lower region of the intermediate tower section 155 is gripped by the lift beam 320, where the lift beam 320 is held in place by the climbing elements 300_{1,2}, 310_{1,2} that are attached to the holes 420, 430 in the jacking supports 185, 190. The lift beam 320 may also be supported by lift beam guide, which is extended into the holes 420, 430 on the jacking supports 185, 190.

FIG. 14 illustrates movement of a remaining skidding carriage 170 which is used to duly locate the lower tower section 165 to the lift centre position. The lower section provides a base of a tower. It will be appreciated that certain embodiments of the present invention are useable with multi section elongate structures which may have two, three, four or more structural sections which need to be successively lifted and then secured to one another. In FIG. 14, the lower tower section 165 is moved to the lift position location located in between the two supports 185, 190 of the jacking station 180. In other words, at the lift position location shown, a central point of the bottom of the lower tower section 165 in FIG. 14 is equidistant from the first jacking support 185 and the further jacking support 190. This is achieved by moving the associated skid 170, on which the lower tower section 165 is mounted, along the tracks 150 from an initial position to the lift position. It will be appreciated that the lower tower section 165 may be mounted to the skid using bolts, internal flange clamps, locking mechanisms, or the like. It will be appreciated that the lower tower section 165 may be sufficiently supported on the skid 170 to help prevent the lower tower section 165 from toppling when exposed to wind. At the lift position, the lower tower section 165 is near the edge region 120 of the quayside region 110.

FIG. 15 illustrates the lower tower section 165 being connected to the base of the intermediate tower section 155 and climbing elements 300, 310 being connected. The lift beam 320, that in FIG. 15 is gripped around the lower region of the intermediate tower section, 155 may be lowered by the lowering of the climbing elements 300_{1,2}, 310_{1,2} as described above. In other words the intermediate tower section 155 may be lowered into position once the lower tower section 165 is in place. Optionally, the lift beam 320 may provide a small index rotation and translation movement of up to +/−2° of the intermediate tower section 155 to allow rotation alignment of the intermediate tower section 155 and the lower tower section 165.

Optionally, the indexing and alignment can be performed by the skid (holding the intermediate tower) rather than the lift beam. Optionally either the lift beam or the skid can be used to do this.

When the partially-assembled wind turbine, including the upper tower section 140, nacelle 142, rotor hub 143, rotor blades 800_{1,2,3}, and intermediate tower section 155 are in position above the lower tower section 165, the intermediate tower section 155 is secured to the lower tower section 165 by bolting and/or welding and/or clamping or the like. In FIG. 15, the bottom flange of the intermediate tower section 155 is secured to a top flange of the lower tower 165.

FIG. 16 illustrates a wind turbine tower 1600 and nacelle and three rotor blades being lifted at the jacking station away from a skidding carriage. In other words, the wind turbine portion, including three tower sections 140, 155, 165, nacelle 142, rotor hub, and rotor blades 800_{1,2,3}, are raised above the ground by the jacking rig 180. The lift beam 320 grips the wind turbine tower 1600 and is lifted by the climbing elements 300_{1,2}, 310_{1,2} as detailed above. Optionally the assembled wind turbine is raised by at least 1, 5, 10, 20, 30, or the like metres. It will be appreciated that the wind turbine tower 1600 may include the three tower sections 140, 155, 160 or more.

Also shown in FIG. 16 is the quayside gripper 132 which can be part of a platform mounting system for securing the floating platform 130 in place. The platform mounting system also can include a pair of overhanging supports 1610_{1,2}. The overhanging supports 1610 are truss structures formed from steel, any alloy, composite, or the like. It will be appreciated that the platform mounting system may be arranged differently, for example, with 1, 3, 4, or more overhanging supports. The floating platform 130 has three primary legs 135_{1,2,3}. Each primary leg 135 has a buoyant base 1620. The buoyant base 1620 may be inflated with air or with water to change the buoyancy of the floating platform 130. In other words, by replacing water in the buoyant base 1620 with air, the buoyancy of the device may be increased. By adjusting the buoyancy of each primary leg 135_{1,2,3}, the floating platform 130 may be levelled. This may be helpful in stabilising the structure, responding to wind moments, or the like. Rather than an inflatable device the legs are rigid housings and water/air can be selectively pumped in/out to control buoyancy.

FIG. 17 helps illustrate how the jacking station can itself be translated along associated running tracks 1710_{1,2} to align a lower part of the wind turbine tower 1600 with a one of the three main/primary legs of the tripod floating platform. The associated running tracks 1710_{1,2} are located on their respective overhanging supports 1610_{1,2}. Each jacking support 185, 190 is itself mounted on a respective short section of track. In other words the first base 195₁ of the first jacking support may be movable along the associated running track 1710₁. Similarly, the further base 195₂ of the further jacking support 190 may be movable along the associated running track 1710₂. In this way each support can independently be located over water. At this point the wind turbine is duly located over the floating platform and once in a desired position the turbine is installed/secured on the floating platform.

In FIG. 17, the jacking supports 185, 190 slide along the associated running track 1710_{1,2}. The jacking supports 185, 190, via the lift beam 320 and climbing elements 300, 310, hold the wind turbine tower 1600 in suspension above the third primary leg 135₃. As the weight of the jacking supports 185, 190 and the wind turbine tower 1600 is transferred to the running track 1710, the overhanging supports may ballast to support the additional weight. In other words, by replacing water in the overhanging supports 1710 with air, the buoyancy of the support may be increased. In certain embodiments, the overhanging support may be statically fixed to the land or seabed to support the weight, or be cantilevered off a barge, vessel or similar.

FIGS. 18 and 19 illustrate the wind turbine tower 1600 being lowered vertically into position on the third primary leg 135₃ according to the methods that have been described above. The lift beam 320 may optionally provide an index movement of +/−2° to the wind turbine tower 1600 to help assist in correctly positioning the tower 1600 above the leg 135₃. When the tower 1600 is correctly seated, the tower 1600 may be fastened to the leg 135₃ by bolts, pins, locking mechanisms, or the like. A bottom flange of the wind turbine tower 1600 may be secured to the third primary leg 1353. As the weight of the wind turbine is transferred to the floating platform 130, the buoyant bases 1620 on each primary leg 130_{1,2,3} may be inflated with air to the same or differing degrees. The buoyant bases 1620 may help to stabilise the floating platform 130 and/or compensate for wind currents or the like.

FIG. 20 helps illustrate how the jacking station has been moved back towards the quayside and the lift beam has thus been disengaged from the tower. The floating platform and associated WT can now be released and floated to a desired location.

It will be appreciated that the above process for assembling a wind turbine and installing it on a floating platform may also be applied to a floating vessel in, eg, sea, lake, river, or the like instead of at a quayside. It will be appreciated that extra considerations may have to be made, for example for stability of the floating vessel by inflating the bases of the overhanging support 1610 with air to reduce the effect of weight away from the centre of mass of the floating vessel leading to tipping.

FIGS. 21 to 31 illustrate an assembly process of a wind turbine including installation onto a floating platform. It will be appreciated that the process illustrated in FIGS. 21 to 31 may correspond to the process illustrated in FIGS. 1 to 20.

FIG. 21A, FIG. 21B, FIG. 21C illustrate moving an upper tower section of a wind turbine in line drawing form with three different views.

FIG. 22A, FIG. 22B, FIG. 22C illustrate installing an intermediate tower section of a wind turbine in line drawing form with three different views.

FIG. 23A, FIG. 23B, FIG. 23C illustrate using a land-based crane to install wind turbine blades in line drawing form with three different views.

FIG. 24A, FIG. 24B, FIG. 24C illustrate adjusting grip of jacking rig on a partially-assembled wind turbine in line drawing form with three different views.

FIG. 25A, FIG. 25B, FIG. 25C illustrate raising a partially-assembled wind turbine using a jacking rig in line drawing form with three different views.

FIG. 26A, FIG. 26B, FIG. 26C illustrate installing a lower tower section of a wind turbine in line drawing form with three different views.

FIG. 27A, FIG. 27B, FIG. 27C illustrate raising a wind turbine using a jacking rig and removing a skid frame in line drawing form with three different views.

FIG. 28A, FIG. 28B, FIG. 28C illustrate moving a wind turbine using a jacking rig and a skid frame onto a floating platform in line drawing form with three different views.

FIG. 29A, FIG. 29B, FIG. 29C illustrate installing a wind turbine onto a floating platform in line drawing form with three different views.

FIG. 30A, FIG. 30B, FIG. 30C illustrate moving a jacking rig onto a quayside in line drawing form with three different views.

FIG. 31A, FIG. 31B, FIG. 31C illustrate releasing a floating platform and towing away in line drawing form with three different views.

FIG. 32A, FIG. 32B, FIG. 32C illustrate a overhanging support rail and quayside gripper in line drawing form with three different views.

In FIG. 32, a overhanging support is provided by 2 or more Submerged Buoyancy Chambers 1610. The chambers 1610 may be arranged such that the floating platform 130 can be entered between them where the Gripper Arms 132 can be used to help provide a secure attachment to the floating platform 130. The Gripper arms 132 may be mounted on a carriage that can be moved parallel with the Quayside allowing the centre of the floating platform 130 to help align with the lifted wind turbine Mast centre line. The running tracks 1710 may be connected to the Buoyancy Chambers 1610 at such a height that the top surface is nominally level. The Buoyancy chambers 1610 are sometimes fully submerged and thus may be insensitive to tidal changes and effects of waves. The land side of the running tracks 1710 may be connected to the Quayside by pivoted or flexible mounts allowing the Buoyancy supported ends of the running track 1710 the ability to rise and fall relative to the quayside. The running tracks 1710 may be connected together by sufficient structure to provide a rigid connection capable of resisting the applied moments from the WTG and jacking rig. As the Jacking rig 180 and assembled wind turbine move along the rails and then the wind turbine (WTG) is landed on to the floating foundation the weight transfer firstly into the quayside and then over the water and ultimately to the floating foundation may require the Buoyancy Support Chambers 1610 to have the amount of water in them varied by pumping. As the amount of force needed may increase the water may be pumped from the chambers 1610 increasing the displaced volume and thus increasing the vertical force applied to support the running tracks 1710.

FIG. 33A, FIG. 33B, FIG. 33C illustrate a land skidding frame in line drawing form with three different views.

In FIGS. 33 and 34, the skid 160, 170, 210 may be illustrated. The skid 160, 170, 210 may include any of the following functions:
Provide a moment carrying connection to support the Tower sections 140, 155, 165;
Locate and skid along the tracks 150;
Provide means of changing the vertical and rotational alignment of the Tower sections 140, 155, 165 such that the plurality of bolts may be aligned at the bolted flange interfaces.

A Knee bearing 3310 may be located under the centre of an upper table 3320 and a lower skidding frame 3330. The skid 210 may include a resilient multi plate elastomer bearing which may provide a small amount of rotational flex in an X-axis, perpendicular Y-axis, or the like index to help the wind turbine mast components to be aligned with the bolt pattern on the parts being supported by the upper table 3320.

Optionally, rotational flex around 3 perpendicular axis (X, Y and Z) is provided. Also a small amount of translational flex in the horizontal plane (X and Y axis) may be provided.

Optionally, the X-axis and Y-axis are in a horizontal plane. Optionally, the horizontal plane may be partially defined by the X-axis being horizontal (side-to-side) in FIG. 33A, or the Y-axis being vertical (top-to-bottom) in FIG. 33A or fully defined by the X-axis being top-to-bottom in FIG. 33A and the Y-axis being side-to-side or the X-axis and the Y-axis may be flipped or the like. The Upper table 3320 may have multiple arms (4 shown although it will be appreciated the upper table 3320 may have any number of arms) on which may be mounted grippers that can secure the inside and/or external flange of the WTG mast. The skid 210 in FIG. 33 has 4 vertical cylinders 3340_{1,2,3,4}. It will be appreciated that alternatively, 1,2,3,5, or more vertical cylinders 3340 may be used. Each vertical cylinder 3340 may have several modes (8 off shown although there may be any number of modes) which are located at the extent of the upper table arms. The cylinders 3340 are mounted with swivel eye bearings to permit relative angular displacement as the height of the cylinders 3340 may be altered causing the upper table to pivot in the X-axis, the Y-axis, or the like. The vertical cylinders 3340 may have several modes of control including any of the following:
Float mode, when the grip system is engaging with the part to be supported to help allow the system to capture the load without over constraint.
Positional mode, which may help allow a grip table to be moved in vertical directions helping to allow rotation about the X-axis and/or the Y-axis travel of anything being held by the grip jaws. This may help to allow bolt pattern alignment under the jacking beam suspended part.
Locked mode, which may allow the skidding frame 210 to react moments from the supported part.

The skid 210 may include a horizontal cylinder 3350. The two horizontal cylinders 3350_{1,2} in FIG. 33 are arranged to provide rotational couple of the upper table 3320 relative to the lower skidding frame. It will be appreciated that any number of horizontal cylinders 3350 may be provided. By their action these cylinders help cause the lower table to index rotate allowing the bolt pattern of any part mounted to the table to rotate. In other words, the skid 210 may enable the wind turbine to pivot on a vertical axis, or the like. The Knee Elastomer bearing 3310 may provide rotation by shear deflection help to remove the issues of stick slip common in sliding plane bearings. The lower skidding frame 3330 may run on sliding bearings on the two rails mounted on the quayside or the deck of the barge to help allow the Skidding Frame and anything mounted on it to be moved to and from the jacking assembly location.

FIG. 35A, FIG. 35B, FIG. 35C illustrate the jacking rig 180 in line drawing form with three different views. The Jacking Support Frames 180 include the first jacking support towers 185 and the further jacking support tower 190 that may be supported by foundations 195 having bearings and guides to locate with the running tracks 1710. A guide may be a path on a jacking support 185, 190 for influencing a direction of the climbing elements 300, 310. The guides may be arranged to provide lateral, vertical and uplift restraint to the jacking supports 185, 190 to help allow them to transmit the support forces and applied moments from the WTG and equipment. In this example the inner edges of the jacking supports 185, 190 have a vertical series of horizontally arranged holes 420, 430 arranged in order to provide the location and support for the Climber systems 300, 310, although it will be appreciated that some jacking supports 185, 190 may not have these features if a different lifting system is used. The jacking supports 185, 190 may also have linear features to help guide and restrain the climbing elements 300, 310 as they move up and down the jacking supports 185, 190.

FIG. 36A, FIG. 36B, FIG. 36C illustrate the climbing elements 300, 310 in line drawing form with three different views. In FIG. 36, the climbing elements 300, 310 include an Upper climbing element 300₂, 310₂ and Lower climbing element 300₁, 310₁ connected by multiple vertically arranged hydraulic cylinders 3610. It will be appreciated that alternatively, the upper and lower climbing elements may be connected by a different mechanism. Mounted on each side of the Upper climbing element 300₂, 310₂ and Lower climbing element 300₁, 310₁ may be multiple spring engaged, hydraulically retracted pins 3620. Each pin 3620 is arranged to help engage with the holes in the sides of the Jacking Supports 185, 190.

The inside of the Upper climbing element 300₂, 310₂ and Lower climbing element 300₁, 310₁ may include linear features or bearings or sets of guide wheels to interact with the linear features up the Jacking Support Towers 185, 190 to allow the climbing elements 300, 310 to be guided and retained as it is moved up and down the jacking rig 180. The Climber system 300, 310 may move by engaging the pins 3620 of the lower climbing element 300₁, 310₁ with the Jacking tower holes 420, 430 and disengaging the pins 3620 of the upper climbing elements 300₂, 310₂. The hydraulic cylinders may extend to align the pins 3620 of the upper climbing element 300₂, 310₂ with holes 420, 430 in the Jacking rig 180. The pins 3620 of the upper climbing element 300₂, 310₂ may be engaged. The pins 3620 of the lower climbing element 300₁, 310₁ may be retracted. Retracting (shortening) the vertical hydraulic cylinders may raise a lower beam of the climbing element 300₁, 310₁ until the pins 3620 are adjacent to the holes 420, 430 in the jacking supports 185, 190. The pins 3620 of the lower climbing element 300₁, 310₁ may be engaged in the holes 420, 430 and weight is transferred. The process may be repeated to continue climbing upwards. It will be appreciated that the process may be carried out in reverse to climb downwards. Each climbing element 300_{1,2}, 310_{1,2} may have an engagement Pin 3630, feature, or the like that helps to locate with the Lift Beam to carry the support forces and react the moments from the wind turbine to allow them to be transmitted to the jacking supports 185, 190.

FIG. 37A, FIG. 37B, FIG. 37C illustrate the lift beam 320 of the jacking rig 180 in line drawing form with three different views. The lift beam 320 may provide partly encircling shape around a centre line 3710. This centreline may help define the centre of lift of the system and nominally the centre line of the assembled wind turbine when being supported by the lift beam 320. The seaward side of a Lift Beam Guide 3720 may be energised so that it may be retracted and extended, helping allow it to pass between the jacking supports 185, 190. This is helpful to assist the lift beam in being brought into the lift arrangement with the first section 145 of the wind turbine. Once correctly aligned the lift beam Guide 3720 may be extended and may engage with the linear features of the Jacking Supports 185, 190 to help provide additional restraint and guidance to the lift beam 320 and supported WTG. Each side of the Lift Beam 320 may have a corresponding feature, a pin clevis 3730 or the like to help locate with the climbing elements 300, 310. When the lift beam 320 is in the correct position the climbing elements 300, 310 may be connected to help provide the lift support for the WTG and lift beam 320. The pin may be hydraulically engaged and disengaged to help provide a more effective operation. Mounted on the Lift Beam 320 and arranged around the open sided aperture in the beam may be multiple grippers (4 shown although it will be appreciated that there may be greater or fewer grippers). A Gripper 3740 may help engage with features on the outside or inside of the WTG tower to help allow the lift forces and support moments of the WTG to be transmitted into the jacking rig 180. As the WTG may be supported from below the centre of gravity, the grippers 3740 may be capable of transmitting at least some of the support forces and moments to help ensure the WTG remains stable. The grippers 3740 may be designed to translate in towards the centreline of the WTG to help accommodate the taper of the WTG tower and help permit correct engagement with the lift features on the WTG outer surface.

FIGS. 38 to 41 illustrate alternative procedures for assembling the wind turbine and/or installing the wind turbine on the floating platform.

FIG. 38A, FIG. 38B, FIG. 38C illustrate an alternative installation of wind turbine blades 800 using the blade guide. Installation of wind turbine blades may also be illustrated in FIGS. 8 to 10. Wind turbine blades 800 may be installed by rotating the nacelle 142 by around 90 degrees and using a twin blade guide from lightweight gantries at the side of the jacking rig 180.

FIG. 39A, FIG. 39B, FIG. 39C illustrate an alternative installation of wind turbine blades using the blade guide on the floating vessel 130.

FIG. 40A, FIG. 40B, illustrate an alternative to climbing elements for raising and lowering a lift beam of the jacking rig 180. In the alternative arrangement outlined in FIG. 40, the lift beam 320 may be raised and lowered using multifall blocks, synchronised winches, cylinders, or the like.

FIG. 41A, FIG. 41B illustrate an alternative assembly of a wind turbine and installation onto the floating platform 130 whereby the assembly may take place on overhanging supports 1610. In the alternative arrangement outlined in FIG. 41, the wind turbine may be assembled over water or the like and the fully assembled WTG may thereby be inserted into the floating platform 130. An advantage of installation on the overhanging supports 1610 is that assembly may be achieved without translation of the assembled WTG at the final stage before.

FIGS. 42 to 50 illustrate an alternative assembly/disassembly of a wind turbine whereby the assembly takes places on a floating vessel in line drawing form with three different views A, B, C for each Figure. It will be appreciated that the process illustrated in FIGS. 42 to 50 may broadly correspond to the process illustrated in FIGS. 1 to 20 apart from the above-indicated differences.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of providing a wind turbine (WT), comprising the steps of:
at a lift position location, erecting a wind turbine portion that comprises at least one elongate tower and a nacelle member on an upper end region of the elongate tower and at least one blade member, by providing a lower tower section at the lift position location, lifting the lower tower section vertically via at least one lift support thereby providing a lifted tower section, urging at least one incoming further tower section to the lift position location, to a position under a preceding tower section, and securing a top region of the incoming further tower section to a lower region of a lifted preceding tower section; whereby
lifting tower sections comprises providing tower sections, one-by-one, to the lift position location that is at a desired position proximate to at least one lift support, gripping an incoming tower section via at least one lift beam mounted on respective climber elements movable with respect to each lift support, and via the climber elements raising the gripped tower section upwards to a raised position.

2. The method as claimed in claim 1, further comprising:
raising or lowering the climber elements whilst supporting load and resisting moments imparted by a lifted portion of the wind turbine.

3. The method as claimed in claim 1, further comprising:
supporting the wind turbine portion from below a center of gravity of lifted tower sections.

4. The method as claimed in claim 1,
whereby lifting tower sections further comprises:
progressively assembling the wind turbine portion using lifting from below a center of gravity with moment stability and lift loads applied to tower flanges internal and/or external to the incoming tower section.

5. The method as claimed in claim 1, further comprising:
once a desired elevation is reached, extending a lift beam guide element of the lift beam into holes of a lift support thereby transferring weight and bending moments of a raised tower section from the lift beam directly to the lift support and/or via at least one gripper mounted on the lift beam, engaging with the outside or inside of a tower section thereby allowing lift forces and support moments of the wind turbine portion to be transmitted to the lift support.

6. (canceled)

7. The method as claimed in claim 1, whereby the climber elements can progressively climb a rigid frame structure and/or whereby the climber elements each include a lower climbing element and an upper climbing element, each lower climbing element being optionally connected to a respective upper climbing element by at least one hydraulic cylinder and the method optionally further comprises raising or lowering the climber elements by repeatedly increasing and decreasing a distance between a spaced apart lower climbing element and an upper climbing element of each climber element.

8. (canceled)

9. (canceled)

10. (canceled)

11. The method as claimed in claim 1, further comprising:
repeatedly lifting a respective tower section and providing an incoming tower section under one or more lifted tower sections until a tower portion comprising a plurality of tower sections is erected, and/or lifting tower sections by providing tower sections, one-by-one, to the lift position location that is at a desired position proximate to at least one lift support, gripping an incoming tower section via one or more lift beams vertically separated and mounted on respective climber elements movable with respect to each lift support, and via the climber elements raising the gripped tower section upwards to a raised position.

12. (canceled)

13. The method as claimed in claim 1, further comprising:
providing tower sections one-by-one to the lift position location by providing a plurality of upright tower sections on respective skidding frames running on a rail track, and selectively urging each skidding frame along a region of the rail track to the lift position location and/or providing tower sections one-by-one to the lift position location by providing a plurality of upright tower sections via SPMTs (self-propelled modular transporter) and/or supporting a supported tower section of an elongate tower comprising a plurality of tower sections, via a lift beam supported by each lift support, and simultaneously supporting a further tower section of the elongate tower via a skidding frame.

14. (canceled)

15. (canceled)

16. The method as claimed in claim 1, further comprising:
supporting a supported tower section of an elongate tower comprising a plurality of tower sections, via one or more lift beams vertically separated and supported by each lift support, and simultaneously supporting a further tower section of the elongate tower via a skidding frame.

17. The method as claimed in claim 1, further comprising:
subsequent to erecting said a wind turbine portion, urging the erect wind turbine portion laterally over a region of a floating platform to a mounting position and optionally providing a region of the floating platform under the erect wind turbine and optionally holding the floating platform at a desired relative position via at least one gripping member.

18. The method as claimed in claim 17, further comprising:
as the erect wind turbine portion is urged over said a region, holding the floating platform at a desired relative position via at least one gripper member and optionally via a pair of opposed gripper members, and as the wind turbine portion is urged over said a region optionally selectively varying a buoyancy of at least one respective buoyancy element proximate to the gripper member to balance a transfer of weight provided by the wind turbine portion with a buoyancy associated with the buoyancy element.

19. (canceled)

20. (canceled)

21. The method as claimed in claim 17, further comprising:
selectively securing one or more blade members to a rotor hub carried with the nacelle, via a crane element, with the nacelle facing the floating platform or rotating the elongate tower and/or the nacelle at the lift position location and securing each blade member to the rotor hub via a gantry system or other means.

22. The method as claimed in claim 17, further comprising:
the lift position location is a quayside zone adjacent to a body of water in which the floating platform floats or is a zone on a barge itself floating in a body of water and optionally when a barge is used, the floating platform can be located offshore in a remote location.

23. (canceled)

24. The method as claimed in claim 1, further comprising:
prior to securing the lower region, determining a first dimension relative position of the lower region via lateral movement of at least one lift support along a respective lift support track and/or determining a further dimension position of the tower end region via selectively laterally moving at least one gripper member that grips a region of the floating

25. (canceled)

26. The method as claimed in claim 1, further comprising:
prior to securing the lower region, determining a degree of rotation of a lifted tower section by selecting a control index rotation of a lifting beam that supports the lifted tower section and prior to securing tower sections, either to each other or a foundation, optionally providing a quantity of rotation to the lifted or lower tower section for the purpose of alignment by controlled rotation of a lifting beam that supports the tower sections.

27. (canceled)

28. The method as claimed in claim 1, further comprising:
via a final skidding frame supporting a lower tower section, providing a moment carrying connection to support a tower section and/or providing a locating and skidding connection to horizontal rails of a rail track and/or providing a vertical height adjusting connection and a rotational alignment adjusting connection.

29. Apparatus for providing a wind turbine (WT), comprising:
at least one lift support each comprising a respective climber element for relative movement up or down the lift support; and
a rail track extending from a first rail track end to a remaining rail track end; wherein the rail track is disposed for delivery of successive tower sections each mounted on respective skid frames to a lift position location proximate to said lift support.

30. The apparatus as claimed in claim 29, further comprising:
a lift beam mounted on respective climber elements moveable with respect to each lift support for gripping an incoming tower section at a lift position location and/or at least one gripper mounted on the lift beam for engaging with an outside or an inside of a tower section thereby allowing lift forces and support moments of the wind turbine portion to be transmitted to the at least one lift support and/or a lift beam guide element of the lift beam for transferring weight and bending moments of a raised tower section of the wind turbine from the lift beam directly to the at least one lift support.

31. (canceled)

32. The apparatus as claimed in claim 29, further comprising:
each lift support comprises a jacking tower that includes a vertically arranged track of blind or through holes and/or each lift support is mounted on a respective track for translating the lift support along said respective track.

33. The apparatus as claimed in claim 29, further comprising:
said respective climber elements are for raising a tower section of the wind turbine to a raised position and/or comprise a lower climbing element connected to an upper climbing element by a pair of hydraulic cylinders.

34. (canceled)

35. (canceled)

36. (canceled)

37. (canceled)

38. (canceled)
